(19) United States
(12) Patent Application Publication
(10) Pub. No.: US 2013/0083858 A1
(43) Pub. Date: Apr. 4, 2013

(54) VIDEO IMAGE DELIVERY SYSTEM, VIDEO IMAGE TRANSMISSION DEVICE, VIDEO IMAGE DELIVERY METHOD, AND VIDEO IMAGE DELIVERY PROGRAM

(71) Applicant: Tatsuji Moriyoshi, Tokyo (JP)

(72) Inventor: Tatsuji Moriyoshi, Tokyo (JP)

(73) Assignee: NEC CORPORATION, Minato-ku, Tokyo (JP)

(21) Appl. No.: 13/699,242

(22) PCT Filed: May 23, 2011
(86) PCT No.: PCT/JP2011/061731

§ 371 Date: Nov. 20, 2012

(30) Foreign Application Priority Data
May 24, 2010 (JP) 2010-118098

(51) Int. Cl. H04N 7/26

(52) U.S. Cl. CPC H04N 19/00951
USPC 375/240.23

(57) ABSTRACT

A transmission device includes: a bit stream storage unit for transforming video signals into a plurality of bit streams having different bit rates in advance and storing those; a receiving device information acquisition unit which acquires information pertaining to a receiving device from the receiving device; a selection control unit which determines the bit rate and the variable-length encoding method for the bit stream transmitted to the receiving device; and a transmission unit which transmits, to the receiving device, the bit stream having the bit rate and the variable-length encoding method determined by the selection control unit. The selection control unit determines the bit rate and the variable-length encoding method so that the amount of the video image data before being subjected to variable-length encoding is at the maximum and so that the bit rate is within the maximum bit rate which can be processed by the receiving device.

### TECHNICAL FIELD

The present invention relates to a video image delivery system, a video image transmission device, a video image delivery method, and a video image delivery program. More specifically, the present invention relates to a video image delivery system and the like, which transmit video images with a still greater amount of video image information within a range that can be processed by a receiving device.

### BACKGROUND ART

Delivery of video images utilizing a network such as the Internet has been spread. With the delivery of video images utilizing the network, it is common to transmit video images by performing compression encoding on digitalized video image signals in order to suppress the volume of the data to be transmitted.

As the techniques for generating encoded data by encoding video image signals with a low bit rate, a high compression rate, and a high picture quality and for outputting the video image signals by decoding the encoded data, known as international standards and widely used are H. 261, H.263 standardized by ITU (International Telecommunication Union), MPEG-1, MPEG-2, MPEG-4 of ISO (International Organization for Standardization), and VC-1 of SMPTE (Society of Motion Picture and Television Engineers), for example.

Further, there is also H.264 standardized recently by ITU together with ISO. This H.264 is known to be able to improve the compression efficiency and to improve the picture quality.

In order to compress the video image signals efficiently, those video image encoding techniques use a hybrid encoding method which is a combination of techniques such as inter-frame prediction using motion compensation, orthogonal transformation and quantization of prediction error signals, and entropy encoding of quantized orthogonal transformation coefficient.

FIG. 17 is an explanatory chart showing the structure of a video image encoding device 1000 using an H.264 method depicted in Non-Patent Document 1. The video image encoding device 1000 is constituted with: a motion estimation (ME) unit 1001; a motion compensation (MC) unit 1002; an intra prediction mode judging unit 1003; an intra prediction (IP) unit 1004; a selection unit 1005; a discrete integer transform (DIT) unit 1006; a quantize (Q) unit 1007; an inverse quantization (IQ) unit 1008; an inverse discrete integer transform (IDIT) unit 1009; a variable-length coding (VLC) unit 1010; a deblock filtering unit 1011; a frame buffer 1012; a subtraction unit 1013; and an adder unit 1014.

In order to improve the compression efficiency and to improve the picture quality, the H.264 method also employs the techniques of intra prediction which performs prediction by using neighboring pixel information within a same image frame and a deblock filter which reduces encoding noise generated in the image of the encoded result.

The image data of the frames already encoded in the past is stored in the frame buffer 1012. When a new image is inputted, encoding processing is executed in a block unit of 16×16 pixels called a macro block (MB). The motion estimation unit 1001 detects the positional change in the corresponding image blocks between the inputted image and the encoded image stored in the frame buffer 1012, and outputs the motion vector information corresponding to the positional change.

The motion compensation (MC) unit 1002 performs motion compensation processing by using the encoded image stored in the frame buffer 1012 and the motion vector information supplied from the motion estimation (ME) unit 1001, and outputs the motion compensation predicted image. The intra prediction mode judging unit 1003 selects a proper (in general, the encoding efficiency thereof becomes the highest) intra prediction mode by using the inputted image and the encoded macro block image information within the same image, and outputs the mode information thereof.

The intra prediction (IP) unit 1004 performs intra prediction (in-screen prediction) by using the encoded macro block image information within the same image and the intra prediction mode information supplied from the intra prediction mode judging unit 1003, and outputs the intra prediction image.

The selection unit 1005 selects a proper (in general, also the encoding efficiency thereof becomes the highest) image from the motion compensated prediction image supplied from the motion compensation (MC) unit 1002 and the intra prediction image supplied from the intra prediction (IP) unit 1004, and outputs it as the prediction image. The case of selecting the motion compensation prediction image may be called an inter mode, and the case of selecting the intra prediction image may be called an intra mode.

The subtraction unit 1013 subtracts the prediction image outputted from the selection unit 1005 from the inputted image, and outputs a prediction error image. The discrete integer transform (DIT) unit 1006 performs orthogonal transformation processing similar to DCT (Discrete Cosine Transform) on the prediction error image, the quantize (Q) unit 1007 performs quantization processing, and outputs a quantized orthogonal transformation coefficient sequence. The variable length encoding (VLC) unit 1010 encodes the quantized orthogonal transformation coefficient sequence with a prescribed rule, and outputs a video image bit stream (simply referred to as a bit stream hereinafter) that is the encoded result. This is the output bit stream of the H.264-type encoding device.

Further, the inverse quantization (IQ) unit 1008 performs inverse quantization processing and the inverse discrete integer transform (IDIT) unit 1009 performs inverse discrete integer transformation processing on the quantized orthogonal transformation coefficient sequence, the adder unit 1014 adds it to the prediction image outputted from the selection unit 1005, and the deblock filtering unit 1011 further performs deblock filtering processing thereon to generate a local decoded image. The local decoded image is stored in the frame buffer 1012 and utilized for encoding successive frames.

Note here that the processing executed in the variable length encoding (VLC) unit 1010 is reversible compression processing except for exceptional cases. The H.264 method employs two kinds as the variable length encoding methods, such as CAVLC (Content-based Adaptive Variable Length Code) and CABAC (Content-based Adaptive Binary Arithmetic Code).

Both CAVLC and CABAC are reversible encoding. Therefore, the result of decoding performed by using CAVLC on the bit stream acquired by performing encoding on the quantized orthogonal transformation coefficient sequence by CAVLC and the result of decoding performed by using CABAC on the bit stream acquired by performing encoding on the same orthogonal transformation coefficient sequence by CABAC are consistent with each other necessarily, and both are consistent with the orthogonal transformation coefficient sequence that is not encoded yet.

However, the encoding methods of CAVLC and CABAC are different. Thus, even when a same orthogonal transformation coefficient sequence is encoded, the encoding amounts while being encoded are different. Like a Haffman code, CAVLC achieves compression by allotting a short code to an encoded word with a high generation probability and allotting a long code to an encoded word with a low generation probability. In the meantime, CABAC achieves compression by performing binarization with a prescribed method and performing an arithmetic encoding.

The encoding efficiency depends on the characteristics of the image. However, it is considered that the generation encoding amount when employed to a typical image is smaller by about 10 to 15% for CABAC than that of CAVLC. In the meantime, there is also a difference in the computation amounts required for encoding and decoding processing due to the difference in the encoding methods. In general, the computation amount is greater for CABAC that uses the arithmetic code.

In Patent Document 1, depicted is a technique for shortening the processing time of CABAC decoding that includes a great amount of computation. In order to achieve smooth reproduction playback by shortening the decoding processing time at the time of special playback such as a double-speed playback and an inverse playback, this technique stores in advance intermediate data in which a part of CABAC decoding processing has been done and uses the intermediate data for special playback in a case where a key frame used for the special playback is encoded with CABAC.

Further, it is also suggested to use a variable-length encoded bit stream different from CABAC as the intermediate data. Considered is a mode which uses a bit stream that is once CABAC decode-processed and then CAVLC encoded thereafter as the intermediate data. This is a technique which utilizes such a characteristic that the computation amount of CAVLC is smaller in general than that of CABAC.

Further, in Patent Document 2, depicted is a technique which is designed to reduce the data amount of video image data without causing deterioration in the image quality. This technique performs decoding of a variable length code according to a variable length encoding method used in MPEG-2 on the data of MPEG-2, for example, performs variable length decoding processing with a better encoding efficiency than that used in MPEG-2 for the acquired mode information, motion vector information, the orthogonal transformation coefficient information and the like, and outputs expanded MPEG-2 data.

For example, the encoding efficiency of CABAC is higher than that of the variable length encoding method of MPEG-2. Thus, it is considered to generate expanded MPEG-2 data using CABAC. The variable length encoding is reversible compression, so that the image quality is not deteriorated even when different variable length encoding methods are used. This technique utilizes such a characteristic that the encoding efficiency of CABAC, for example, is higher in general than that of the variable length encoding method of MPEG-2.

Other than those, there are also related patent documents as shown in the followings. In Patent Document 3, depicted is a video image delivery system which receives a stream that fits capacity information according to the capacity information that is informed to the server from the terminal In Patent Document 4, depicted is a video image encoding device which optimizes the encoding operation by properly selecting the size when dividing each picture of the video image into macro blocks. In Patent Document 5, depicted is a video image delivery method which stores data that is in an intermediate-extended state of video data, preforms encoding by determining the encoding amount of the data according to the load of the network, and delivers it.
Patent Document 1: Japanese Unexamined Patent Publication 2008-072182
Patent Document 2: Japanese Unexamined Patent Publication 2005-094693
Patent Document 3: WO 2007105362
Patent Document 4: Japanese Unexamined Patent Publication 2007-201558
Patent Document 5: Japanese Unexamined Patent Publication Hei 09-298749
Non-Patent Document 1: ITU-TRecommendation H.264 “Advanced video coding for generic audiovisual services”, March, 2005

The technique disclosed in Patent Document 1 increases the speed of operations for the data that requires high-speed processing such as a special playback by using a variable length encoding method with a small computation amount of decoding processing. However, when data encoded with CABAC is re-encoded with CAVLC, the data amount becomes increased in general and the consumption of the storage medium is increased.

In the meantime, the technique disclosed in Patent Document 2 performs re-encoding by a variable length encoding method with a still higher encoding efficiency in order to reduce the data amount of the video image data so as to reduce the consumption of the storage medium. However, the computation amount required for decoding is generally large with the variable length encoding method with the high encoding efficiency, thereby generating side effects such as extending the processing time and increasing the power consumed in the decoding processing.

As described, the encoding efficiency of the variable length encoding method and the computation amount of the decoding processing are in a trade-off relation in many of the cases. Thus, there are cases where the variable length encoding method suited for a certain purpose or a certain use environment is not necessarily suited for other environments.

This will be described by referring to an example used in a video delivery system. FIG. 18 is an explanatory chart showing the structure of a video delivery system 1100 which delivers a bit stream generated by a video image encoding device 1000 shown in FIG. 17. The video delivery system 1100 is constituted by mutually connecting a transmission device 1110 which transmits a bit stream and a receiving device 1120 which receives and regenerates the bit stream.

The transmission device 1110 is constituted with a bit stream storage unit 1111, a selection control unit 1112, a transmission unit 1113, and a receiving device information receiving unit 1114. The receiving device 1120 is constituted with a receiving unit 1121, a variable-length code decoding unit 1122, an image outputting unit 1123, a receiving device information transmitting unit 1124, a receiving device information storage unit 1125, and a display unit 1126.

The bit stream storage unit 1111 stores the bit stream that is the data acquired by encoding video signals in advance by the video image encoding device 1000 shown in FIG. 17 for a plurality of video image encoding methods and a plurality of bit rates.

At the time of delivering the video, the receiving device 1120 transmits the receiving device information stored in the receiving device information storage unit 1125 to the transmission device 1110 from the receiving device information transmitting unit 1124. The receiving device information contains the video image encoding method decodable by the receiving device 1120, the maximum frame size, the maximum bit rate and the like, which can be dealt therewith, for example. For example, in the standards of H.264, the maximum frame size, the bit rate, and the like which can be handled by the decoding device are defined by numerical values of the profile and the level. Thus, it is also considered to use the profile and the level as the receiving device information.

The transmission device 1110 receives the receiving device information at the receiving device information receiving unit 1114, and supplies it to the selection control unit 1112. In the selection control unit 1112, the receiving device 1120 selects and reads out the bit stream of a decodable condition from the bit stream storage unit 1111 based on the receiving device information, and supplies it to the transmission unit 1113. The transmission unit 1113 transmits the bit stream to the receiving device 1120.

In the receiving device 1120, the receiving unit 1121 receives the bit stream. The bit stream received by the receiving device 1120 is transformed into encoding information to be described later by the variable-length code decoding unit 1122, and transformed into image signals by the image outputting unit 1123. The image signals are outputted to the display unit 1126. Note here that the image outputting unit 1123 performs a series of processing (inverse quantization, inverse discrete integer transformation, motion compensation, intra prediction, deblock filtering, and the like) except for the decoding processing of the variable length code out of the video image decoding processing.

Note here that it is desirable for the selection control unit 1112 to select the bit stream of a variable length encoding method with the encoding efficiency that is as high as possible in order to suppress the data amount of the bit stream transmitted from the transmitting device 1110 to the receiving device 1120 and to suppress consumption of the band of the transmission path. In the meantime, there is a limit in the processing capacity of the receiving device 1120, so that there is a possibility that the bit stream using the variable length encoding method with which the encoding efficiency is high but the decoding processing amount is large cannot be decoded. In such case, it is appropriate to use a variable length encoding method with which the decoding processing amount is small, even though the encoding efficiency is rather degraded.

This relationship will be described by referring to an example shown in FIGS. 19 to 21. Here, CAVLC and CABAC as the two kinds of variable length encoding methods of H.264 will be described as a way of example. FIG. 19 is an explanatory chart showing an example of a transmission bit rate of a case where the two kinds such as CAVLC and CABAC are used as the variable length encoding methods in the video delivery system 1100 shown in FIG. 18. The lateral axis shows the video image information amount at a stage before variable length encoding is performed, and the longitudinal axis shows a transmission bit rate after the variable length encoding is performed.

The video image encoding described in FIG. 17 is divided roughly into steps of three stages. The first stage is “inter-frame prediction and intra-frame prediction” executed by the motion estimation (ME) unit 1001—the selection unit 1005 and by the deblock filtering unit 1011—the adder unit 1014, the second stage is “orthogonal transformation and quantization of prediction error signal” executed by the discrete integer transform (DIT) unit 1006—the inverse discrete integer transform (IDIT) unit 1009, and the third stage is “entropy encoding” executed by the variable length coding (VLC) unit 1010. Elimination of the time redundancy and spatial redundancy is executed in each of the stages to provide the data that can be transmitted with a still smaller transmission bit rate.

The video image information amount herein is the information amount (entropy, unit bit) in a state where the first and second stages are completed. In this Description, the data in a state where the first and second stages are completed on the image signals is referred to as “encoded information”, and the data in a state where the first to the third stages are completed is referred to as “bit stream”. For CAVLC and CABAC, the encoding information at a point where the first and second stages are completed is the same. However, the bit streams thereof at the third stage turn out as bit streams of different forms.

In general, the encoding efficiency is higher with the CABAC than that of CAVLC. Thus, when the same video image information amount is variable-length encoded, the transmission bit rate becomes lower with CABAC. Now, it is assumed that there is a given video delivery receiving device, and this video delivery receiving device is considered to be able to receive the bit stream of up to the maximum bit rate that can be decoding-processed within a specific computation capacity.

In this case, it is common that the computation amount of the decoding processing of the variable length code increases as the bit rate increases. Further, the decoding processing amount of CABAC is greater than that of CAVLC, so that the maximum bit rate that can be decoding-processed within a specific computation capacity is lower for CABAC than that of CAVLC. As a way of example, the receiving device is assumed to be able to perform decoding processing of 15 Mbps (Mega bits per second) with CAVLC and up to 10 Mbps with CABAC.

FIG. 20 is an explanatory chart showing examples of a transmission bit rate and a video image information amount transmitted when the video delivery system 1100 shown in FIG. 18 uses CABAC as the variable length encoding method. As can be seen from FIG. 20, CABAC can perform decoding processing only up to 10 Mbps at the maximum, when CABAC with a high encoding efficiency is used for suppressing consumption of the band of the transmission path. Therefore, it is not possible to transmit a larger video image information amount than the corresponding lateral axis position.

FIG. 21 is an explanatory chart showing examples of transmission bit rate and video image information amount transmitted when the video delivery system 1100 shown in FIG. 18 uses CAVLC as the variable length encoding method. CAVLC can perform decoding processing only up to 15 Mbps, so that the maximum video image information amount that can be transmitted is greater than the case of CABAC shown in FIG. 20. However, when the transmission bit rate is lower than about 10 Mbps, the transmission bit rate thereof is higher than the case of using CABAC. Thus, consumption of the band of the transmission path becomes large.

As described, there is a trade-off relation in the encoding efficiency and the decoding processing amount between the different variable length encoding methods. When a variable length encoding method with a high encoding efficiency is used, the transmission bit rate can be made smaller. Instead, a greater computation capacity is required. Thus, there are cases where it is not possible to transmit video images of a larger video image information amount within a range that can be processed with the receiving device by simply using the variable length encoding method of a high encoding efficiency. However, there is no technique focusing on this respect depicted in Patent Documents 1 to 5. Therefore, it is not possible to overcome such issue with those techniques.

An object of the present invention is to provide a video image delivery system, a video image transmission device, a video image delivery method, and a video image delivery program, which can select the optimum bit stream depending on the processing capacity of the receiving device and the transmission path band, and can transmit video images of a still larger video image information amount within a range that can be processed by the receiving device.

### DISCLOSURE OF THE INVENTION

In order to achieve the foregoing object, the video image delivery system according to the present invention is a video image delivery system constituted by mutually connecting a transmission device and a receiving device, wherein: the transmission device includes a bit stream storage unit which transforms in advance video image signals into a plurality of bit streams of different bit rates and stores those, a receiving device information acquisition unit which acquires receiving device information containing processing efficiency information when the receiving device performs decoding processing on the bit streams encoded by variable length encoding methods for each of a plurality of kinds of variable length encoding methods from the receiving device, a selection control unit which determines the variable length encoding method and a bit rate of the bit stream that is to be transmitted to the receiving device based on the receiving device information, and a transmission unit which transmits the bit stream of the variable length encoding method and the bit rate determined by the selection control unit to the receiving device; the receiving device includes a plurality of variable-length code decoding units for variable-length decoding the bit streams encoded by corresponding to each of the plurality of kinds of variable length encoding methods, and an image outputting unit which transforms variable-length decoded signals into video images and outputs those; and the selection control unit of the transmission device determines the variable length encoding method and the bit rate based on the processing efficiency information in such a manner that the bit rate is within a maximum bit rate that can be processed by the receiving device and that the video image information amount before being variable-length encoded becomes maximum.

In order to achieve the foregoing object, the video image transmission device according to the present invention is a video image transmission device connected mutually to a receiving device, which includes: a bit stream storage unit which transforms in advance video image signals into a plurality of bit streams of different bit rates and stores those; a receiving device information acquisition unit which acquires receiving device information containing processing efficiency information when the receiving device performs decoding processing on the bit streams encoded by variable length encoding methods for each of a plurality of kinds of variable length encoding methods from the receiving device; a selection control unit which determines the variable length encoding method and a bit rate of the bit stream that is to be transmitted to the receiving device based on the receiving device information; and a transmission unit which transmits the bit stream of the variable length encoding method and the bit rate determined by the selection control unit to the receiving device, wherein the selection control unit of the transmission device determines the variable length encoding method and the bit rate based on the processing efficiency information in such a manner that the bit rate is within a maximum bit rate that can be processed by the receiving device and that the video image information amount before being variable-length encoded becomes maximum.

In order to achieve the foregoing object, the video image delivery method according to the present invention is a video image delivery method used with a video image delivery system constituted by mutually connecting a receiving device to a transmission device including a bit stream storage unit which transforms video image signals into a plurality of bit streams of different bit rates and stores those in advance, wherein: a receiving device information acquisition unit of the transmission device acquires receiving device information containing processing efficiency information when the receiving device performs decoding processing on the bit streams encoded by variable length encoding methods for each of a plurality of kinds of variable length encoding methods from the receiving device; a selection control unit of the transmission device determines the variable length encoding method and a bit rate of the bit stream that is to be transmitted to the receiving device based on the receiving device information in such a manner that the bit rate is within a maximum bit rate that can be processed by the receiving device and that the video image information amount before being variable-length encoded becomes maximum; a transmission unit of the transmission device transmits the bit stream of the variable length encoding method and the bit rate determined by the selection control unit to the receiving device; a variable-length code decoding unit of the receiving device performs variable-length decoding of the bit streams that are encoded by corresponding to each of the plurality of kinds of variable length encoding methods; and an image outputting unit of the receiving device transforms the variable-length code decoded signals into video images and outputs those.

In order to achieve the foregoing object, the video image delivery program according to the present invention is a video image delivery program used with a video image delivery system constituted by mutually connecting a receiving device to a transmission device including a bit stream storage unit which transforms video image signals into a plurality of bit streams of different bit rates and stores those in advance, and the program causes a computer provided to the transmission device to execute: a procedure for acquiring receiving device information containing processing efficiency information when the receiving device performs decoding processing on the bit streams encoded by variable length encoding methods for each of a plurality of kinds of variable length encoding methods from the receiving device; a procedure for determining the variable length encoding method and a bit rate of the bit stream that is to be transmitted to the receiving device based on the receiving device information in such a manner that the bit rate is within a maximum bit rate that can be processed by the receiving device and that the video image information amount before being variable-length encoded becomes maximum; and a procedure for transmitting the bit stream of the variable length encoding method and the bit rate determined by the selection control unit to the receiving device.

The present invention is structured to determine the variable length encoding method and the bit rate in such a manner that the bit rate is within a maximum bit rate that can be processed by the receiving device and that the video image information amount before being variable-length encoded becomes maximum as described above, and to transmit the bit stream with the variable-length encoding method and the bit rate. Therefore, it is possible to provide the video image delivery system, the video image transmission device, the video image delivery method, and the video image delivery program, which can select the optimum bit stream depending on the processing capacity of the receiving device and the transmission path band, and can transmit video images of a still larger video image information amount within a range that can be processed by the receiving device.

### BRIEF DESCRIPTION OF THE DRAWINGS

FIG. 1 is an explanatory chart showing a video image delivery system according to a first exemplary embodiment of the present invention;

FIG. 2 is an explanatory chart showing examples of a bit stream stored in a bit stream storage unit of a transmission device shown in FIG. 1;

FIG. 3 is an explanatory chart for describing receiving device information shown in FIG. 1 in more details;

FIG. 4 is an explanatory chart for describing video image information amount information shown in FIG. 1 in more details;

FIG. 5 is a flowchart showing operations of a selection control unit shown in FIG. 1;

FIG. 6 is an explanatory chart showing which method out of a first and a second variable length encoding methods is selected in the video image distribution system shown in FIGS. 1 to 4 when the video image information amount is changed;

FIG. 7 is an explanatory chart showing operations of the video image delivery system shown in FIGS. 1 to 5 when the kinds of the variable length encoding methods are expanded to three kinds;

FIG. 8 is an explanatory chart showing a video image delivery system according to a second exemplary embodiment of the present invention;

FIG. 9 is an explanatory chart showing examples of bit streams stored in a bit stream storage unit of a transmission device shown in FIG. 8;

FIG. 10 is a flowchart showing operations of a selection control unit shown in FIG. 8;

FIG. 11 is an explanatory chart showing an example of video image information amount information shown in FIG. 8, and an example of operations of the video image delivery system based thereupon;

FIG. 12 is an explanatory chart showing a video image delivery system according to a third exemplary embodiment of the present invention;

FIG. 13 is an explanatory chart showing examples of bit streams stored in a bit stream storage unit of a transmission device shown in FIG. 12;

FIG. 14 is an explanatory chart showing an example of video image information amount information shown in FIG. 12, and an example of operations of the video image delivery system based thereupon;

FIG. 15 is an explanatory chart showing a video image delivery system according to a fourth exemplary embodiment of the present invention;

FIG. 16 is an explanatory chart showing an example of encoding information stored in an encoding information storage unit of a transmission device shown in FIG. 15;

FIG. 17 is an explanatory chart showing the structure of a video image encoding device of H.246 type depicted in Non-Patent Document 1;

FIG. 18 is an explanatory chart showing the structure of a video delivery system which delivers a bit stream created by the video image encoding device shown in FIG. 17;

FIG. 19 is an explanatory chart showing examples of transmission bit rates of a case where two kinds such as CAVLC and CABAC are used as the variable length encoding methods in the video delivery system shown in FIG. 18;

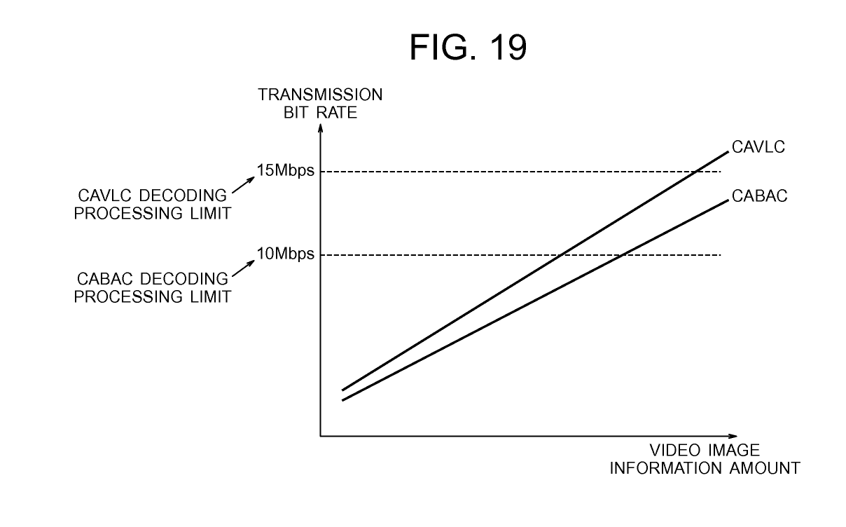

FIG. 20 is an explanatory chart showing examples of transmission bit rates and video image information amount of a case where CABAC is used as the variable length encoding methods in the video delivery system shown in FIG. 18; and

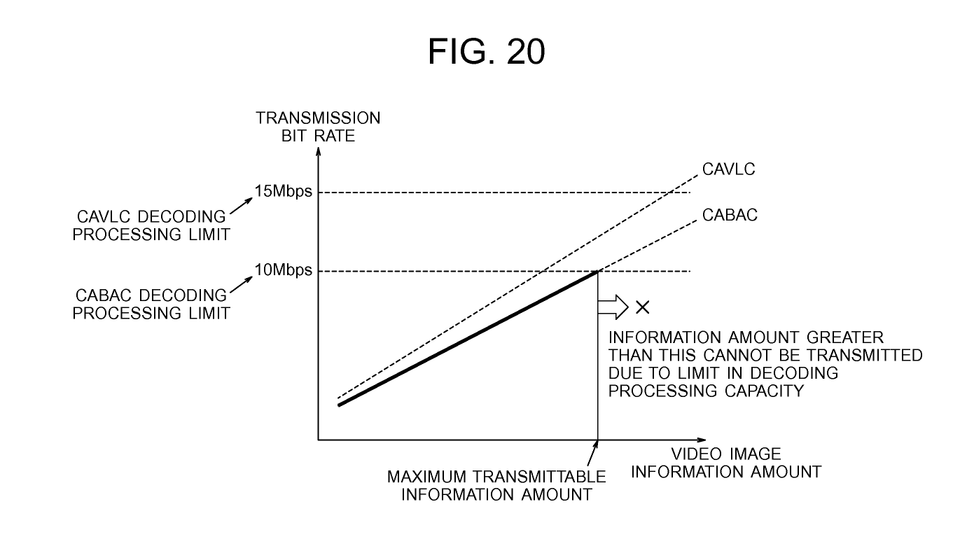

FIG. 21 is an explanatory chart showing examples of transmission bit rates and video image information amount of a case where CAVLC is used as the variable length encoding methods in the video delivery system shown in FIG. 18.

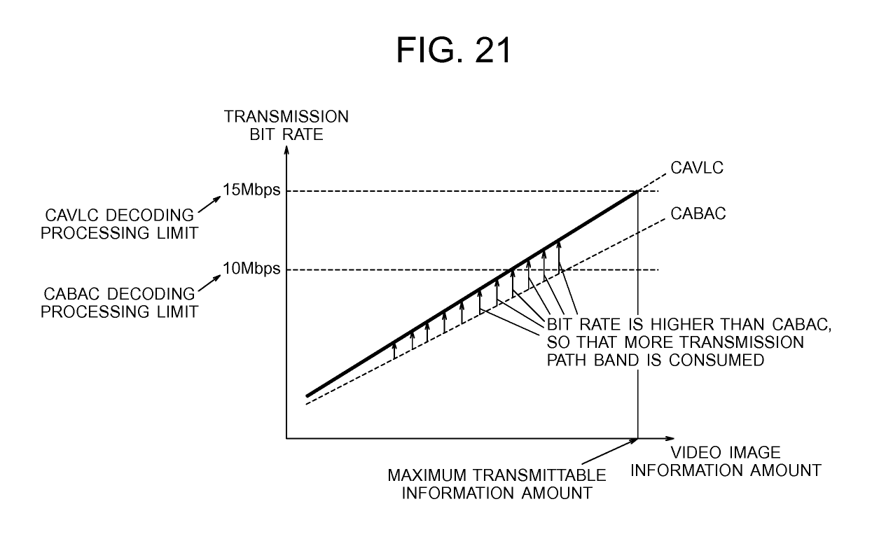

### BEST MODES FOR CARRYING OUT THE INVENTION

### First Exemplary Embodiment

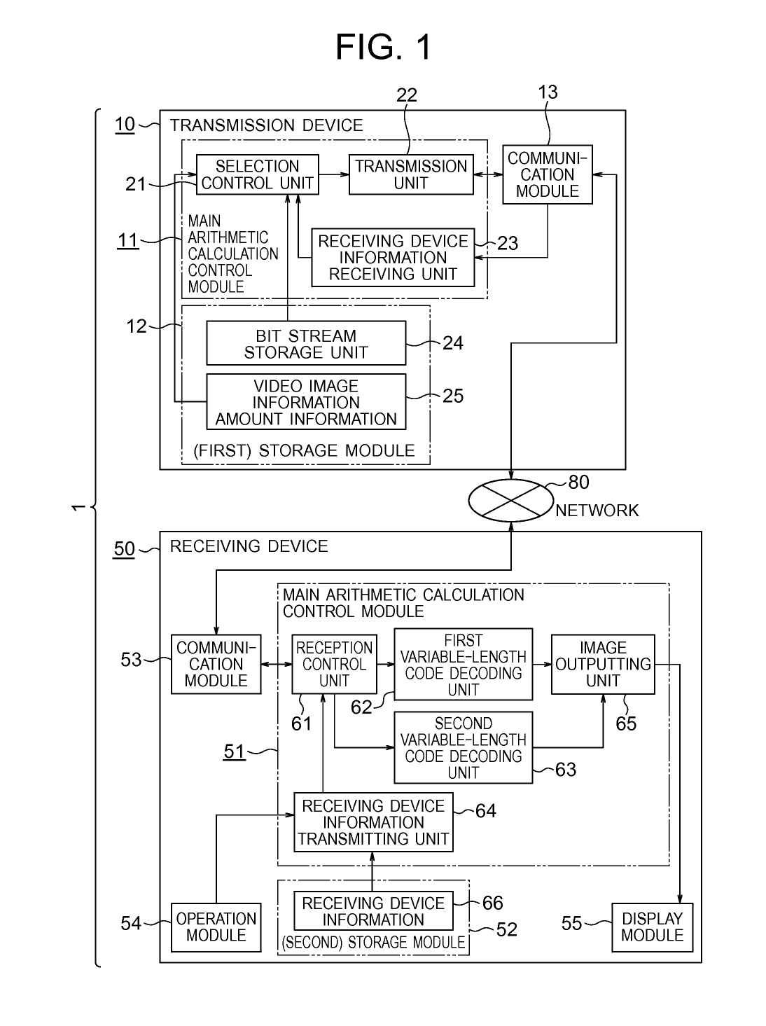

Hereinafter, the structure of a first exemplary embodiment according to the present invention will be described by referring to the accompanying drawing FIG. 1.

First, the basic contents of the exemplary embodiment will be described. Thereafter, more specific contents thereof will be described.

A video image delivery system 1 according to the exemplary embodiment is a video image delivery system constituted by mutually connecting a transmission device 10 and a receiving device 50. The transmission device 10 includes: a bit stream storage unit 24 which transforms in advance video image signals into a plurality of bit streams of different bit rates and stores those; a receiving device information acquisition unit 23 which acquires receiving device information containing processing efficiency information when the receiving device performs decoding processing on the bit streams encoded by the variable length encoding methods for each of a plurality of kinds of variable length encoding methods from the receiving device; a selection control unit 21 which determines the variable length encoding method and the bit rate of the bit stream that is transmitted to the receiving device based on the receiving device information; and a transmission unit 22 which transmits the bit stream of the variable length encoding method and the bit rate determined by the selection control unit to the receiving device. In the meantime, the receiving device 50 includes: a plurality of variable-length code decoding units 62 to 63 for variable-length-code decoding the bit streams encoded by corresponding to each of the plurality of kinds of variable length encoding methods; and an image outputting unit 65 which transforms the variable-length-code decoded signals into video images and outputs those. Further, the selection control unit 21 of the transmission device 10 determines the variable length encoding method and the bit rate based on the processing efficiency information in such a manner that the bit rate is within the maximum bit rate that can be processed by the receiving device 50 and that the video image information amount before being variable-length encoded becomes maximum. The processing efficiency information herein is information regarding the maximum bit rate that can be processed by the receiving device.

Further, the receiving device 50 includes: a storage module 52 which stores receiving device information in advance; and a receiving device information transmitting unit 64 which transmits the receiving device information to the transmission device. The receiving device information acquisition unit 23 of the transmission device 10 receives the receiving device information from the receiving device.

With such structure, the video image delivery system 1 can select the optimum bit stream in accordance with the processing capacity of the receiving device and the transmission path band, and can transmit the video images with a still greater amount of video image information within a range that can be processed by the receiving device.

This will be described in more details hereinafter.

FIG. 1 is an explanatory chart showing the video image delivery system 1 according to the first exemplary embodiment of the present invention. The video image delivery system 1 is constituted by connecting the transmission device 10 and the receiving device 50 via a network 80. The transmission device 10 is a typical computer device, which includes: a computation control module (CPU: Central Processing Unit) 11 which is the main unit for executing computer programs; a (first) storage module 12 which stores data; and a communication module 13 which performs data communication with other computers via the network 80.

In the CPU 11, each of the selection control unit 21, the transmission unit 22, and the receiving device information acquisition unit 23 operates as computer programs. Further, a storage region as the bit stream storage unit 24 is secured in the storage module 12, and video image information amount information 25 to be described later is also stored therein.

In the meantime, the receiving device 50 is also a typical computer device, which includes: a computation control module (CPU) 51 which is the main unit for executing computer programs; a (second) storage module 52 which stores data; a communication module 53 which performs data communication with other computers via the network 80; an operation module 54 which receives operations from the user; and a display module 55 which displays received video images.

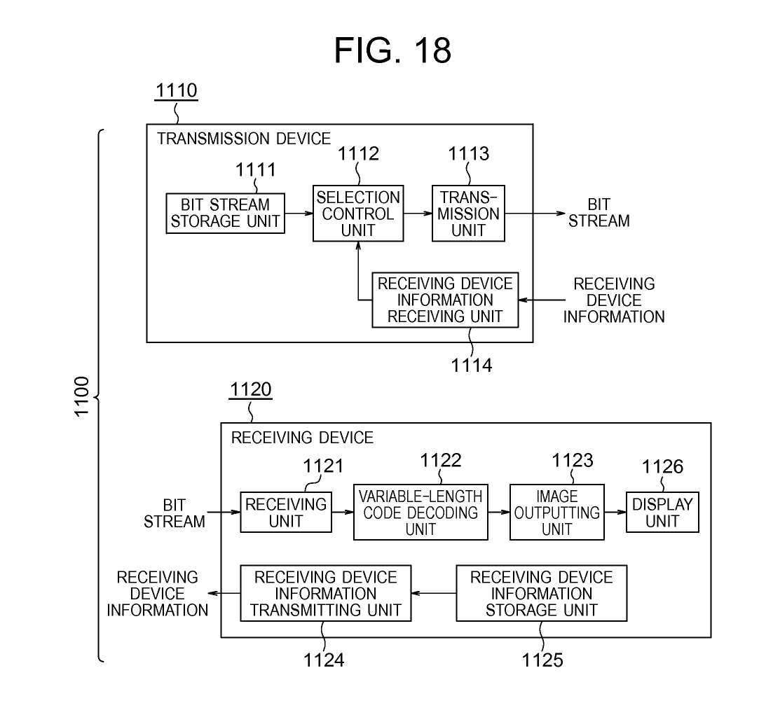

In the CPU 51, each of a reception control unit 61, a first variable-length code decoding unit 62, a second variable-length code decoding unit 63, a receiving device information transmitting unit 64, and an image outputting unit 65 operates as computer programs. Further, receiving device information 66 is stored in the storage module 52. Operations of the transmission unit 22 of the transmission device 10 and the image outputting unit 65 of the receiving device 50 are the same as the operations of the transmission unit 1113 and the image outputting unit 1123 shown in FIG. 18, respectively.

In the receiving device 50, the receiving device information transmitting unit 64 upon receiving a video viewing start operation from the user via the operation module 54 transmits the receiving device information 66 to the transmission device 10 via the communication module 53. In the receiving device 50, the receiving device information acquisition unit 23 receives the receiving device information 66 via the communication module 13 and supplies it to the selection control unit 21. The selection control unit 21 selects the optimum one from a plurality of bit streams 101 to 106 stored in the bit stream storage unit 24 based on the receiving device information 66, and the transmission unit 22 transmits it via the communication module 13.

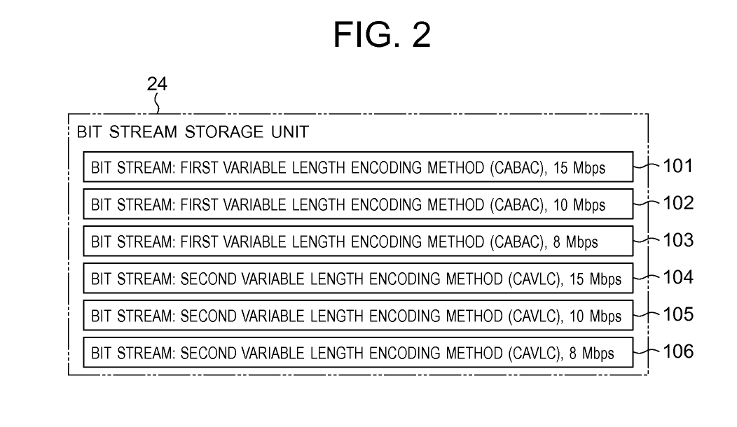

FIG. 2 is an explanatory chart showing an example of the bit streams stored in the bit stream storage unit 24 of the transmission device 10 shown in FIG. 1. The plurality of bit streams 101 to 106 are stored in the bit stream storage unit 24 for a same video content.

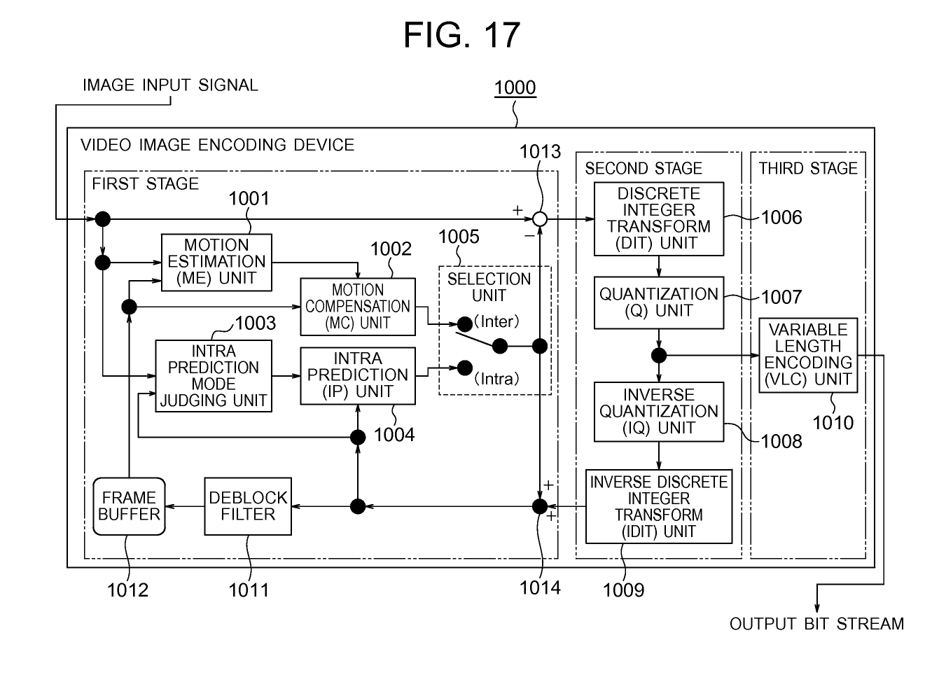

Those bit streams 101 to 106 are data acquired by encoding video signals in advance by the video image encoding device 1000 shown in FIG. 17. Herein, the first variable length encoding method corresponding to the first variable-length code decoding unit 62 and the second variable length encoding method corresponding to the second variable-length code decoding unit 63 are used, and both the first and second variable length encoding methods correspond to a plurality of bit rates.

That is, the bit streams 101 to 103 are all encoded with the bit rates of 15 Mbps, 10 Mbps, and 8 Mbps, respectively, by using the first variable length encoding method. The bit streams 104 to 106 are all encoded with the bit rates of 15 Mbps, 10 Mbps, and 8 Mbps, respectively, by using the second variable length encoding method.

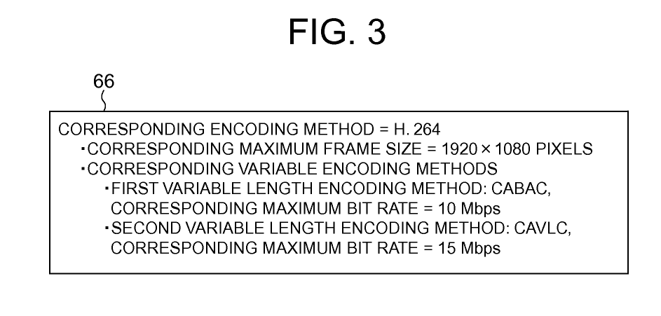

FIG. 3 is an explanatory chart for describing the receiving device information 66 shown in FIG. 1 in more details. The receiving device information 66 is the information regarding the variable length encoding method to which the receiving device 50 corresponds. Both of the first and second variable length encoding methods to which the receiving device 50 corresponds are based on the standards of H.264, so that the frame sizes thereof correspond up to 1920×1080 pixels. The first variable length encoding method is CABAC, and the corresponding maximum bit rate thereof is 10 Mbps. The second variable length encoding method is CAVLC, and the corresponding maximum bit rate thereof is 15 Mbps.

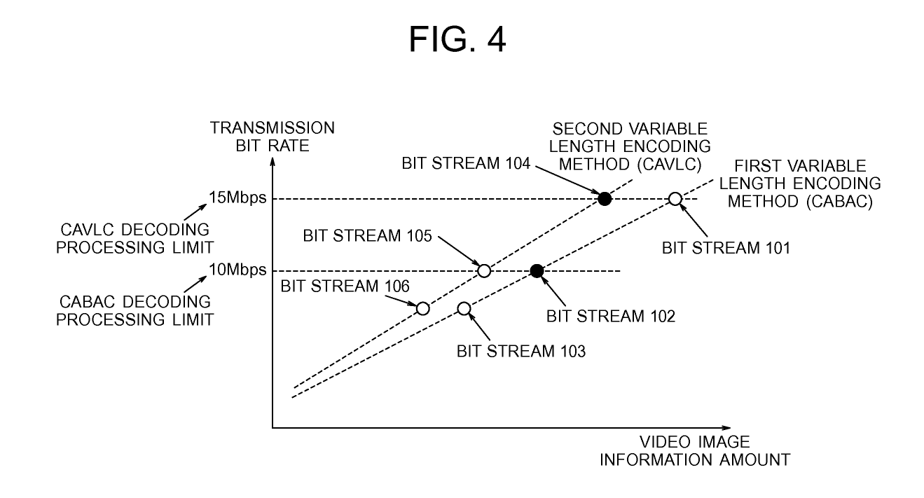

FIG. 4 is an explanatory chart for describing the video image information amount information 25 shown in FIG. 1 in more details. The video image information amount information 25 shows the relation between the bit rate and the video image information amount regarding each of the bit streams 101 to 106 shown in FIG. 2. The video image information amount information 25 is stored to the storage module 12 in advance, and the selection control unit 21 makes reference thereto as necessary.

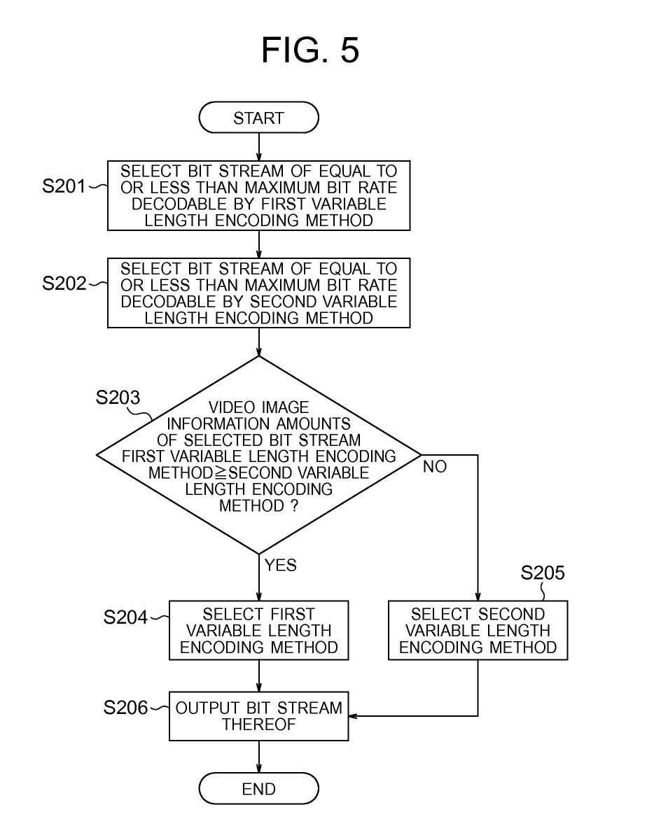

FIG. 5 is a flowchart showing operations of the selection control unit 21 shown in FIG. 1. The selection control unit 21 first refers to the receiving device information 66 and the video image information amount information 25, and selects the bit stream with the bit rate of equal to or less than the maximum bit rate that can be decoding processed by the receiving device 50 among the bit streams 101 to 103 of the first variable length encoding method (step S201). The corresponding maximum bit rate of the second variable length encoding method (CAVLC) in the case shown in FIGS. 1 to 3 is 15 Mbps, so that the selection control unit 21 selects the bit stream 101 whose bit rate is 15 Mbps.

Subsequently, the selection control unit 21 refers to the receiving device information 66 and the video image information amount information 25, and selects the bit stream with the bit rate of equal to or less than the maximum bit rate that can be decoding processed by the receiving device 50 among the bit streams 104 to 106 of the second variable length encoding method (step S202). The corresponding maximum bit rate of the first variable length encoding method (CABAC) in the case shown in FIGS. 4 to 6 is 10 Mbps, so that the selection control unit 21 selects the bit stream 105 whose bit rate is 10 Mbps.

Here, the selection control unit 21 acquires and compares the video image information amounts based on the video image information amount information 25 shown in FIG. 4 regarding each of the bit streams 101 and 105 selected in steps S201 to 202 (step S203). Then, the selection control unit 21 selects the variable length encoding method with which the video image information amount becomes greater (step S204 or 205), outputs the bit streams of the selected variable length encoding method to the receiving device 50 via the transmission unit 22 (step S206), and ends the processing.

In the cases shown in FIGS. 1 to 4, the bit stream 102 with the bit rate of 10 Mbps is selected for the first variable length encoding method (CABAC) and the bit stream 104 with the bit rate of 15 Mbps is selected for the second variable length encoding method (CAVLC) in steps S201 to S202. However, the one with a greater video image information amount is the bit stream 104. Thus, the selection control unit 21 outputs it to the receiving device 50 via the transmission unit 22 in steps S203 to 206.

The receiving device 50 outputs the bit stream to the first variable-length code decoding unit 62 for the case of the first variable length encoding method and to the second variable-length code decoding unit 63 for the case of the second variable length encoding method by corresponding to the variable length encoding method of the bit stream received at the reception control unit 61. The first variable-length code decoding unit 62 and the second variable-length code decoding unit 63 execute decoding processing according to the respective variable length encoding methods, and output the result thereof to the image outputting unit 65. The image outputting unit 65 transforms the decoding-processed bit stream into an image, and outputs it to the display module 55.

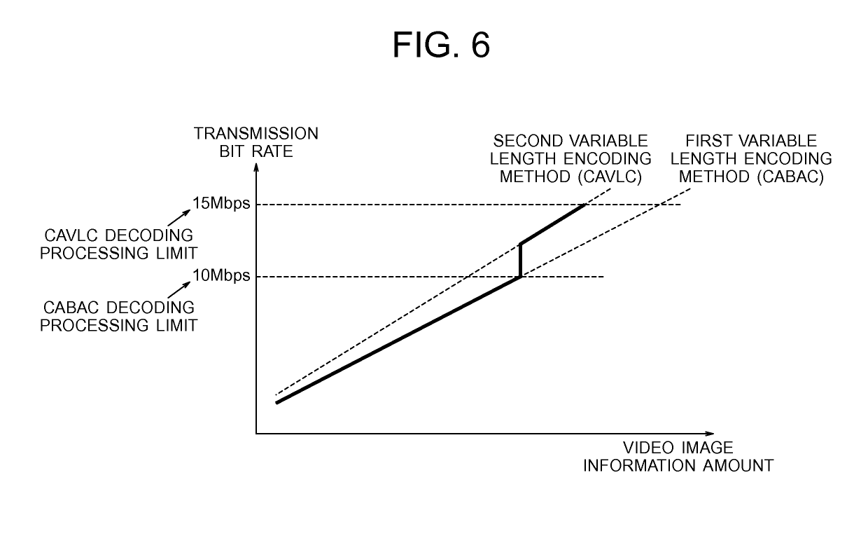

FIG. 6 is an explanatory chart showing which method out of the first and the second variable length encoding methods is selected in the video image delivery system 1 shown in FIGS. 1 to 4 when the video image information amount is changed. A thick solid line shows the variable length encoding method selected by the operations of the exemplary embodiment. When the video image information amount is small, the first variable length encoding method (CABAC) with a high encoding efficiency is selected. In the meantime, the second variable length encoding method (CAVLC) is selected when the video image information amount is large and exceeds the maximum decoding bit rate of the second variable length encoding method. In both cases, a still greater video image information amount can be transmitted with a still lower bit rate.

### Overall Operations of First Exemplary Embodiment

Next, the overall operations of the above-described exemplary embodiment will be described. The video image delivery method according to the exemplary embodiment is used with the video image delivery system which is constituted by mutually connecting the receiving device 50 and the transmission device 10 which includes the bit stream storage unit which transforms in advance video image signals into a plurality of bit streams of different bit rates and stores those, in which: the receiving device information acquisition unit of the transmission device acquires the receiving device information containing information regarding the maximum bit rate that can be processed when the receiving device performs decoding processing on the bit streams encoded by the variable length encoding methods for each of a plurality of kinds of variable length encoding methods from the receiving device; the selection control unit of the transmission device determines the variable length encoding method and the bit rate of the bit stream that is transmitted to the receiving device based on the receiving device information in such a manner that the bit rate is within the maximum bit rate that can be processed by the receiving device and that the video image information amount before being variable-length encoded becomes maximum (steps S201 to 205); the transmission unit of the transmission device transmits the bit stream of the variable length encoding method and the bit rate determined by the selection control unit to the receiving device (step S206); the variable-length code decoding units of the receiving device perform variable-length decoding on the bit streams encoded by corresponding to each of the plurality of kinds of variable length encoding methods; and the image outputting unit of the receiving device transforms the variable-length decoded signals into video images and outputs those.

Note here that each of the above-described operation steps may be put into a program that can be executed by a computer to have those programs executed by the transmission device 10 and the receiving device 50 as the computers which directly execute each of the steps.

With such structures and operations, the exemplary embodiment can provide the following effects.

The first exemplary embodiment of the present invention makes it possible to achieve the video image delivery system which transmits the bit stream having the highest video image information amount within the decodable capacity of the receiving device through transmitting the maximum bit rate information that can be decoding processed by the receiving device regarding a plurality of variable length encoding methods to the transmission device and selecting the variable length encoding method by the transmission device based on the information.

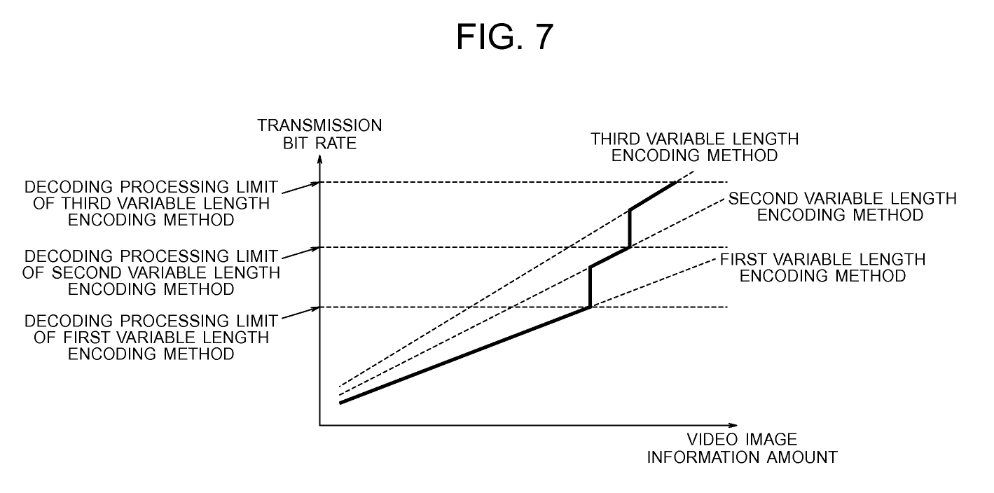

In the first exemplary embodiment described above, the operations of the case where there are two kinds of variable length encoding methods are described. These operations can easily be extended for three or more kinds of variable length encoding methods. FIG. 7 is an explanatory chart showing the operations of the video image distribution system 1 shown in FIGS. 1 to 5 when the kinds of the variable length encoding methods are expanded to three kinds. In FIG. 7, the variable length encoding method to be selected from the three kinds of variable length encoding methods is shown with a thick solid line as in the case of FIG. 6. In this case, it can also be seen that the desired video image information amount can be transmitted with the lowest bit rate within the decodable capacity of the receiving device.

### Second Exemplary Embodiment

In addition to the characteristics of the video image delivery system 1 according to the first exemplary embodiment described above, a video image delivery system 301 according to a second exemplary embodiment of the present invention is so structured that: a bit stream storage unit 324 of a transmission device 310 stores a plurality of bit streams of different bit rates encoded by the first variable length encoding method; the transmission device includes a first variable-length code decoding unit 326 which decodes the bit streams encoded by the first variable length encoding method and outputs encoding information, a second variable-length code encoding unit 327 which encodes the encoding information by the second variable length encoding method and outputs the bit streams; and a selection control unit 321 of the transmission device transmits the bit streams encoded by the first variable length encoding method to the transmission unit for the receiving device via the first variable-length code decoding unit and the second variable-length code decoding unit, when determined to use the second variable length encoding method.

With this structure, it is also possible to achieve the same effects as those of the first exemplary embodiment. Further, only the bit stream encoded by the first variable length encoding method needs to be stored in the bit stream storage unit 324, so that the total volume of the bit streams to be stored can be reduced.

Hereinafter, this will be described in more details.

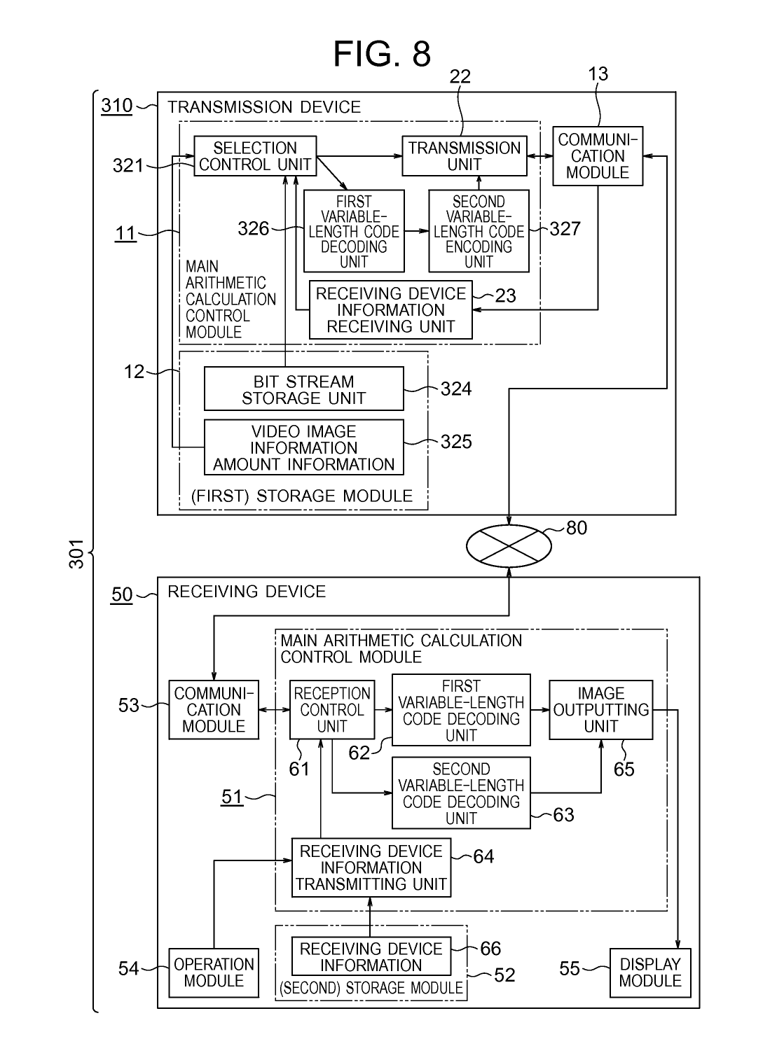

FIG. 8 is an explanatory chart showing the video image delivery system 301 according to the second exemplary embodiment of the present invention. The video image delivery system 301 is constituted by connecting the transmission device 310 and the receiving device 50 via a network 80. The receiving device 50 and the network 80 are the same as those of the first exemplary embodiment.

The transmission device 310 is a typical computer device that is the same as the transmission device 10 according to the first exemplary embodiment, and the structure as hardware is the same as that of the transmission device 10. In the main computation control module 11, each of the selection control unit 321, the transmission unit 22, the receiving device information acquisition unit 23, the first variable-length code decoding unit 326, and the second variable-length code encoding unit 327 operates as computer programs. The transmission unit 22 and the receiving device information acquisition unit 23 are the same as those of the first exemplary embodiment.

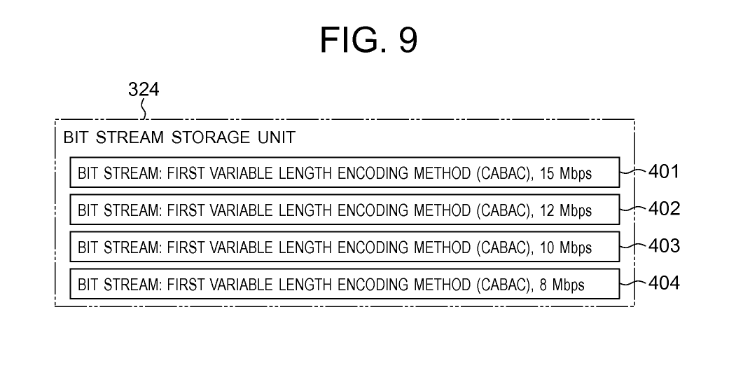

Further, a storage region as a bit stream storage unit 324 is secured in the storage module 12, and video image information amount information 325 is stored therein. FIG. 9 is an explanatory chart showing examples of the bit streams stored in the bit stream storage unit 324 of the transmission device 310 shown in FIG. 8. A plurality of bit streams 401 to 404 encoded by the first variable length encoding method are stored in the bit stream storage unit 324 for a same video content. Those bit streams 401 to 404 are data acquired by encoding video signals in advance by the video image encoding device 1000 shown in FIG. 17.

That is, the bit streams 401 to 404 are all encoded with the bit rates of 15 Mbps, 12 Mbps, 10 Mbps, and 8 Mbps, respectively, by using the first variable length encoding method. The first and second variable length encoding methods are CABAC and CAVLC, which are the same as those of the first exemplary embodiment, respectively. The above-described steps of the first to second stages of the encoding processing are in common to those variable length encoding methods, and both are reversible encoding.

The video image information amount information 325 is the data showing the relation between the bit rate and the video image information amount regarding each of the bit streams 401 to 404 shown in FIG. 9. The video image information amount information 325 is stored to the storage module 12 in advance, and the selection control unit 321 makes reference thereto as necessary. The contents thereof will be described later.

The selection control unit 321 selects one from the bit streams 401 to 404 stored in the bit stream storage unit 324 based on the receiving device information, and determines whether to output the bit stream directly or to output it via the first variable-length code decoding unit 326 and the second variable-length code encoding unit 327.

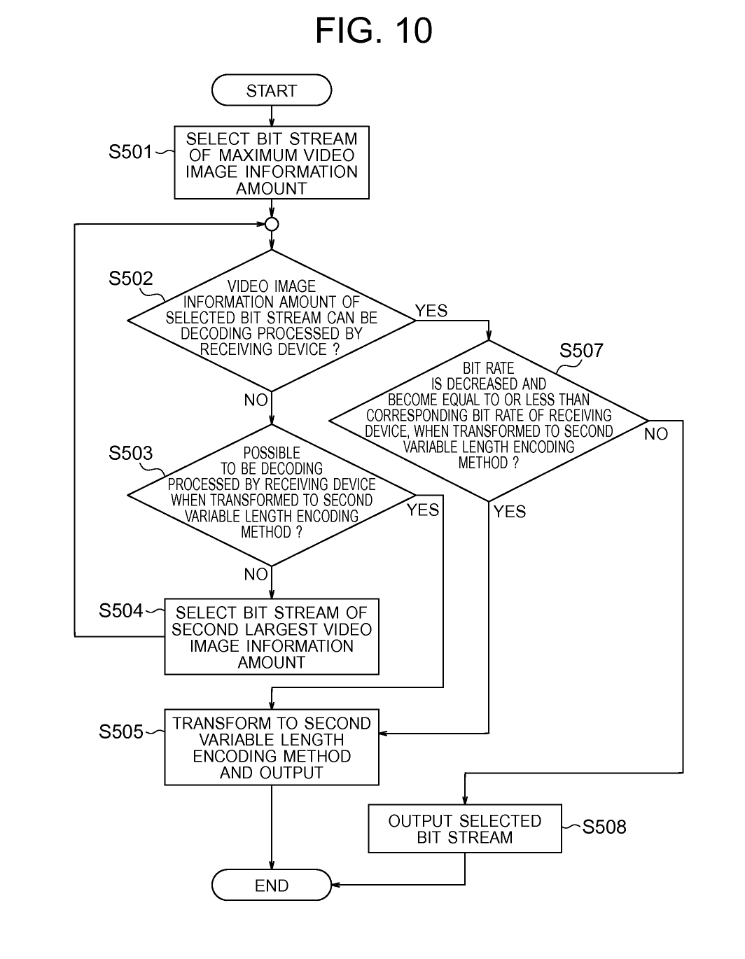

FIG. 10 is a flowchart showing operations of the selection control unit 321 shown in FIG. 8. The selection control unit 321 first selects the bit stream with the bit rate of the greatest video image information amount (step S501). Then, it is judged whether or not the bit rate of the selected bit stream is equal to or less than the maximum bit rate that can be decoding processed by the receiving device (step S502).

When judged that it is not equal to or less than the maximum bit rate that can be decoding processed (step S502: NO), the selection control unit 321 judges whether or not the bit rate when variable length encoding method of the bit stream is changed from the first variable length encoding method to the second variable length encoding method is equal to or less than the maximum bit rate that can be decoding processed by the receiving device (step S503). When the judgment in step S503 is NO, the bit stream whose video image information amount is the second greatest is selected (step S504) and the processing is returned to step S502.

When the judgment in step S503 is YES, the selected bit stream is transformed to that of the second variable length encoding method via the first variable-length code decoding unit 326 and the second variable-length code encoding unit 327 and outputted (step S505).

In the meantime, when the judgment in step S502 is NO, it is judged whether or not the bit rate is decreased when the variable length encoding method of the bit stream is changed from the first variable length encoding method to the second variable length code method and the bit rate with the second variable length encoding method is equal to or less than the maximum bit rate that can be decoded by the receiving device (step S506).

When the judgment in step S506 is YES, the procedure is shifted to step S506. When the judgment in step S506 is NO, the selected bit stream is outputted directly to the transmission unit 22 (step S507). When the bit stream is supplied from the selection control unit 321, the first variable-length code decoding unit 326 performs decoding processing of the first variable length encoding method, and outputs the encoding information such as the mode information, the motion vector information, and the orthogonal transformation coefficient information and the like.

With the exemplary embodiment, as described above, the steps of the first to second stages of the encoding processing are in common to the first and the second variable length encoding methods. Thus, the processing by the first variable length encoding method may not need to transform the selected bit stream into the original video signals completely but may simply transform it back to the encoding information by executing the inverse step of the third stage of the encoding processing described above.

The second variable-length code encoding unit 327 encodes the encoding information by the second variable length encoding method, and outputs the bit stream. The transmission unit 22 transmits the supplied bit stream towards the receiving device. As described above, both the first and the second variable length encoding methods are inverse encoding, so that there is no deterioration of the image quality and the like generated even when the encoding information acquired by decoding the bit stream of the first variable length encoding method is transformed back to the bit stream of the second variable length encoding method.

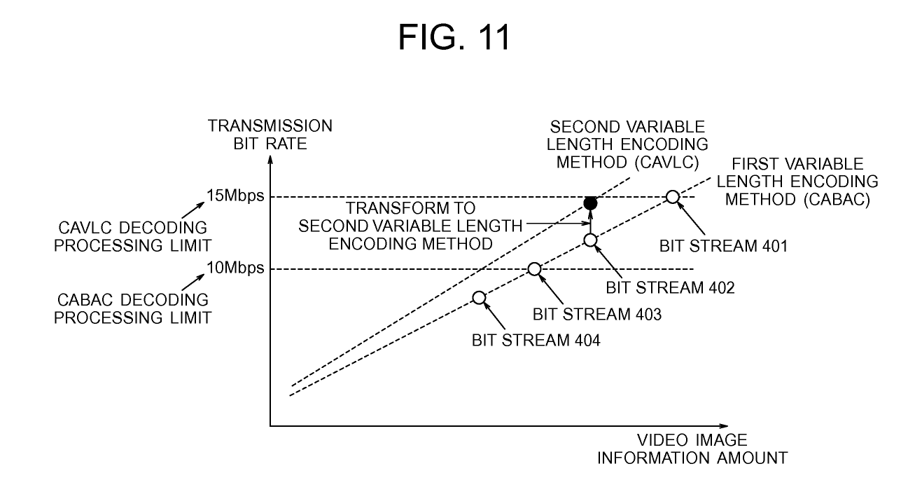

FIG. 11 is an explanatory chart showing an example of the video image information amount information 325 shown in FIG. 8, and an example of operations of the video image delivery system 301 based thereupon. The four kinds of bit streams 401 to 404 corresponding to white circles in FIG. 11 are prepared in the bit stream storage unit 324. Among those, the bit stream 402 exceeds the maximum bit rate that can be decoded by the receiving device with the first variable length encoding method (CABAC). However, the bit stream becomes equal to or less than the maximum bit rate when it is transformed to the second variable length encoding method (CAVLC). Thus, the selection control unit 321 transforms the bit stream 402 to the second variable length encoding method (CAVLC) and transmits it (black circle of FIG. 11) by the operations shown in FIG. 10.

As described above, the second exemplary embodiment of the present invention makes it possible to achieve the video image delivery system which transmits the bit stream having the highest video image information amount within the decodable capacity of the receiving device through selecting by the transmission device whether to transmit the stored bit stream directly or to transmit the bit stream by changing the variable length encoding method based on the receiving device information without storing the bit streams corresponding to the entire variable length encoding methods. That is, it is possible to reduce the total volume of the bit streams to be stored in the transmission device.

### Third Exemplary Embodiment

In addition to the characteristics of the video image delivery system 301 according to the second exemplary embodiment described above, a video image delivery system 601 is so structured that a transmission device 601 includes an encoding information transform unit 628 which transforms encoding information before encoding the encoding information decoded by a first variable-length code decoding unit 626 with the second variable length encoding method, when there is a difference in the encoding information between the first variable length encoding method and the second variable length encoding method.

Further, a receiving device 650 includes an encoding information inverse transform unit 667 which performs transformation of the bit stream received from the transmission device in an inverse direction from that of the encoding information transform unit 628 of the transmission device.

With this structure, it is also possible to acquire the same effects as those of the second exemplary embodiment. Further, the variable length encoding methods with different encoding information can be used in combination as the first and second variable length encoding methods.

Hereinafter, this will be described in more details.

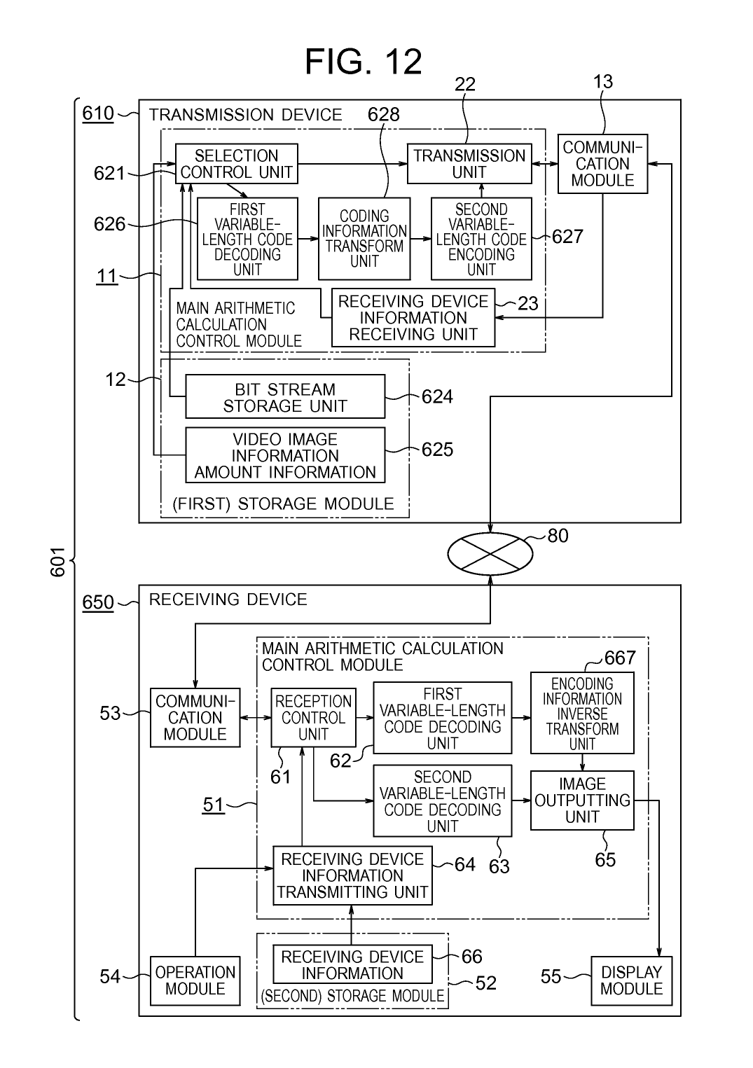

FIG. 12 is an explanatory chart showing the video image delivery system 601 according to the third exemplary embodiment of the present invention. The video image delivery system 601 is constituted by connecting the transmission device 610 and the receiving device 650 via a network 80. The network 80 is the same as that of the first exemplary embodiment.

The transmission device 610 is a typical computer device that is the same as the transmission device 10 according to the first exemplary embodiment and the transmission device 310 according to the second exemplary embodiment, and the structure as hardware is the same as those of the transmission devices 10 and 310. In the main computation control module 11, each of a selection control unit 621, the transmission unit 22, the receiving device information acquisition unit 23, a first variable-length code decoding unit 626, a second variable-length code encoding unit 627, and the encoding information transform unit 628 operates as computer programs.

The transmission unit 22 and the receiving device information acquisition unit 23 are the same as those of the first exemplary embodiment. Further, the first variable-length code decoding unit 626 and the second variable-length code encoding unit 627 are same as the first variable-length code decoding unit 326 and the second variable-length code encoding unit 327 of the second exemplary embodiment, respectively, except that the variable length encoding methods to be used are different (details will be described later). Further, a storage region as the bit stream storage unit 624 is secured in the storage module 12, and video image information amount information 625 is stored therein.

In the meantime, the receiving device 650 is also a typical computer device as in the case of the receiving device 50 according to the first and second exemplary embodiments and the structure thereof as hardware is the same as that of the receiving device 50. In the main computation control module 51, each of a reception control unit 61, a second variable-length code decoding unit 62, a first variable-length code decoding unit 63, a receiving device information transmitting unit 64, an image outputting unit 65, and an encoding information inverse transform unit 667 operates as computer programs. Further, receiving device information 66 is stored in the storage module 52. Other than the encoding information inverse transform unit 667, the exemplary embodiment is the same as the first and second exemplary embodiments except for the variable length encoding method to be used.

With the third exemplary embodiment of the present invention, the steps of the first to second stages of the encoding processing are not in common to the first and second variable length encoding methods, unlike the cases of the first and second exemplary embodiments described above. Thus, the encoding information outputted from the first variable-length code decoding unit 626 is further transformed into encoding information suited for the second variable length encoding method by the encoding information transform unit 628. Then, it is encoded by the second variable-length code encoding unit 627 again with the second variable length encoding method, and outputted as the bit stream.

Here, as a specific example thereof, described is a case where the first variable length encoding method is MPEG-2 type variable length encoding (referred to as MPEG2VLC hereinafter) and the second variable length encoding method is CABAC.

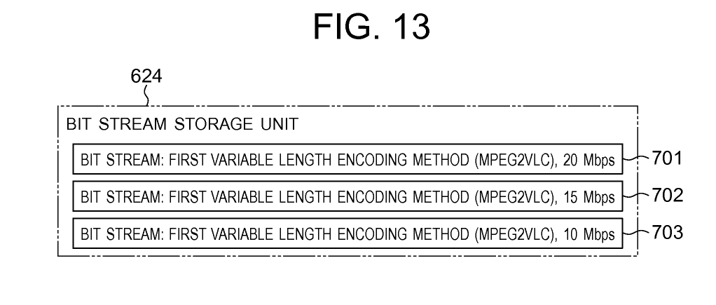

FIG. 13 is an explanatory chart showing examples of the bit streams stored in the bit stream storage unit 624 of the transmission device 610 shown in FIG. 12. A plurality of bit streams 701 to 703 encoded by the first variable length encoding method (MPEG2VLC) are stored in the bit stream storage unit 624 for a same video content. That is, the bit streams 701 to 703 are all encoded with the bit rates of 20 Mbps, 15 Mbps, and 10 Mbps, respectively, by using the first variable length encoding method (MPEG2VLC).

Operations of the selection control unit 621 are the same as those of the second exemplary embodiment. However, the different point with respect to the case of the second exemplary embodiment is that, when the bit streams 701 to 703 by the first variable length encoding (MPEG2VLC) are transformed to the second variable length encoding method (CABAC) and outputted, the first variable-length code decoding unit 626 transforms the bit streams to the encoding information such as the mode information, the motion vector information, and the orthogonal transformation coefficient information, the encoding information transform unit 628 performs encoding information transformation, and then the second variable-length code encoding unit 627 transforms it to the second variable length encoding method (CABAC) and outputs it.

The meanings of the mode information, the motion vector information, and the orthogonal transformation coefficient information are not the same for the first and second variable length encoding methods, i.e., MPEG2VLC and CABAC, so that the encoding information is not in common Thus, the encoding information transform unit 628 reads the orthogonal transform coefficient information (8×8 DCT transform coefficient) of MPEG2VLC as the orthogonal transform coefficient information (8×8 DIT transform coefficient) of CABAC and performs encoding information transformation such as transforming intra+Q macro-block encoding type of MPEG2VLC into 1_N×N macro-block type of CABAC and mb_qp_delta, for example, to transform the encoding information to suit CABAC.

In the receiving device 650, when the bit stream of the second variable length encoding method (CABAC) is received, the second variable-length code decoding unit 62 decodes it and outputs the encoding information such as the mode information, the motion vector information, and the orthogonal transformation coefficient information. Thereafter, the encoding information inverse transform unit 667 performs encoding information transformation processing in an inverse direction form that of the encoding information transform unit 628, and outputs it to the image outputting unit 65. The image outputting unit 65 transforms the bit stream on which decoding processing is performed into an image, and outputs it to the display module 55.

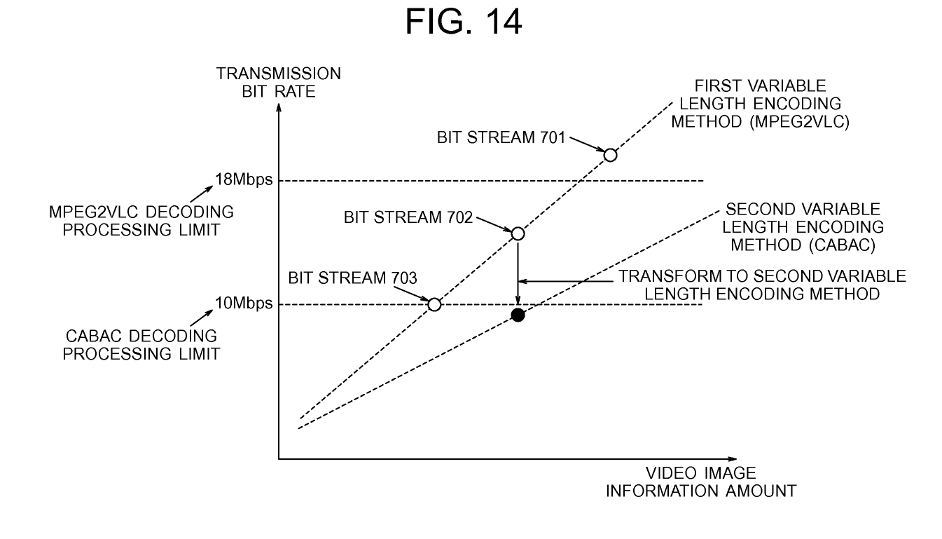

FIG. 14 is an explanatory chart showing an example of the video image information amount information 625 shown in FIG. 12, and an example of operations of the video image delivery system 601 based thereupon. Here, shown is an example of a case where the maximum bit rate of the first variable length encoding method (MPEG2VLC) that can be decoded by the receiving device 650 is 18 Mbps. Among the three kinds of bit streams 701 to 703 corresponding to white circles of FIG. 14, the bit stream 702 has the maximum video image information amount with the bit rate that is equal to or less than the maximum bit rate that can be decoded by the receiving device with the first variable length encoding method (MPEG2VLC).

However, the bit rate can be decreased further when it is transformed to the second variable length encoding method (CABAC). Thus, the bit stream 702 is transformed to the second variable encoding method (CABAC) and transmitted (black circle in FIG. 14) by following the operations of FIG. 14.

As described, the third exemplary embodiment of the present invention makes it possible to achieve the video image delivery system which transmits the bit stream having the highest video image information amount within the decodable capacity of the receiving device through selecting by the transmission device whether to transmit the stored bit stream directly or to transmit the bit stream by changing the variable length encoding method based on the receiving device information without storing the bit streams corresponding to the entire variable length encoding methods. Further, the variable length encoding methods with different encoding information can be used in combination through performing the encoding information transformation and inverse transformation as necessary.

### Fourth Exemplary Embodiment

In addition to the characteristics of the video image delivery system 1 according to the first exemplary embodiment described above, a video image delivery system 801 according to a fourth exemplary embodiment of the present invention is so structured to include: a bit stream storage unit 824 which stores in advance encoding information of a plurality of video images of different bit rates instead of the bit stream storage unit 24; a plurality of variable-length code encoding units 826 to 827, which encodes encoding information with a plurality of kinds of variable length encoding methods and outputs it; and an encoding information transform unit 828 which transforms the encoding information when the variable length encoding method determined by the selection control unit 824 is different from the variable length encoding method of the encoding information.

With this structure, it is also possible to achieve the same effects as those of the third exemplary embodiment. Further, it becomes unnecessary to perform inverse transformation for transforming the bit stream back to the encoding information.

Hereinafter, this will be described in more details.

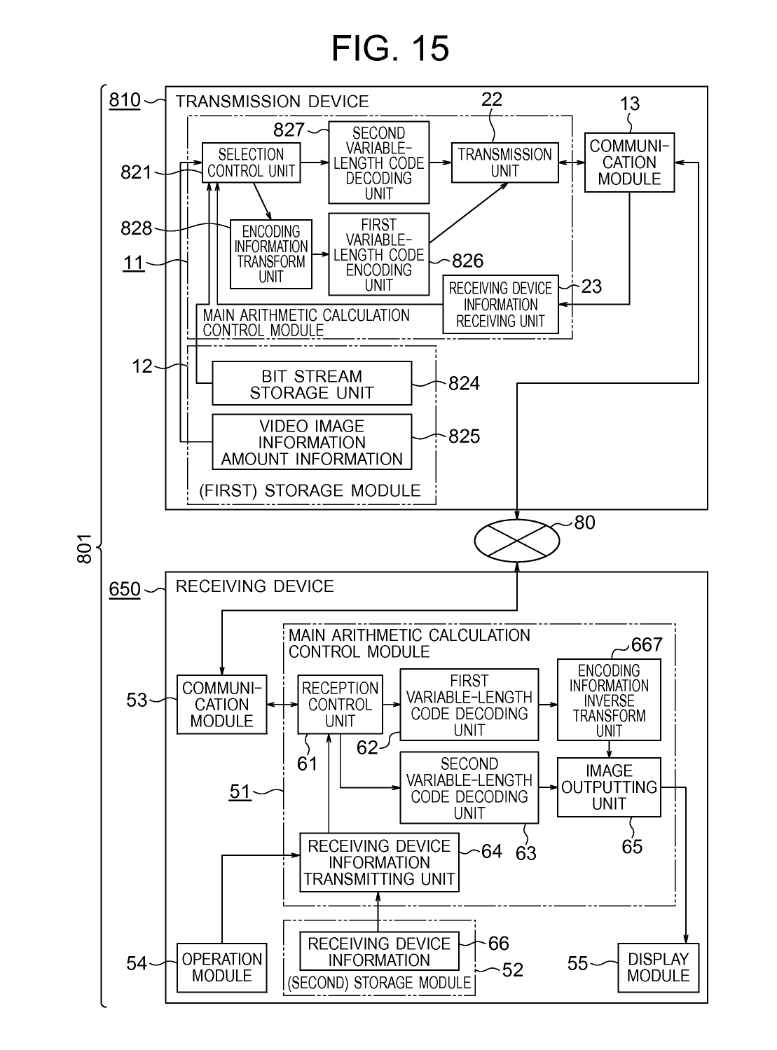

FIG. 15 is an explanatory chart showing the video image delivery system 801 according to the fourth exemplary embodiment of the present invention. The video image delivery system 801 is constituted by connecting a transmission device 810 and a receiving device 650 via a network 80. The network 80 is the same as that of the first exemplary embodiment. Further, the receiving device 650 is the same as that of the third exemplary embodiment.

The transmission device 810 is a typical computer device that is the same as the transmission devices 10, 310, and 610 according to the first to third exemplary embodiments, and the structure as hardware is the same as those of the transmission devices 10, 310, and 610. In the main computation control module 11, each of a selection control unit 821, the transmission unit 22, the receiving device information acquisition unit 23, a first variable-length code encoding unit 826, a second variable-length code encoding unit 827, and the encoding information transform unit 828 operates as computer programs. The transmission unit 22 and the receiving device information acquisition unit 23 are the same as those of the first exemplary embodiment. Further, a storage region as the bit stream storage unit 824 is secured in the storage module 12, and video image information amount information 825 is stored therein.

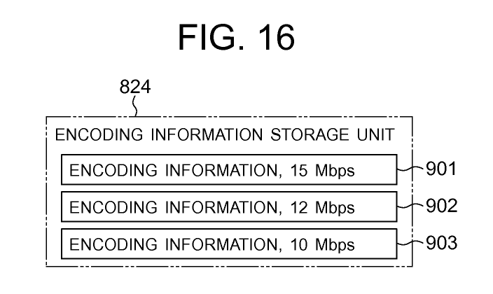

FIG. 16 is an explanatory chart showing an example of encoding information stored in the encoding information storage unit 824 of the transmission device 810 shown in FIG. 15. In the encoding information storage unit 824, stored is the encoding information as the data at the point where the first stage “inter-frame prediction and intra-frame prediction” and the second stage “orthogonal transformation and quantization of prediction error signals” are completed out of the three stages of the variable length encoding described above, e.g., mode information, motion vector information, and orthogonal transformation coefficient information. Further, this encoding information is transformed into a bit stream that can be transmitted to the receiving device by the transmission unit 22 through executing the third stage “entropy encoding” by the first variable-length code encoding unit 826 or the second variable-length code encoding unit 827.

In the encoding information storage unit 824, stored are a plurality of pieces of encoding information 901 to 903 which are the data at the point where processing of the first and second stages is completed in a mode corresponding to the second variable length encoding method for a same video content. Each piece of the encoding information 901 to 903 is encoded with the bit rates of 15 Mbps, 12 Mbps, and 10 Mbps, respectively.

The selection control unit 821 selects the encoding method from the first and second variable length encoding methods for transmitting the stored encoding information based on the receiving device information received from the receiving device 650. For this selection, one of the first and second variable length encoding methods is selected in such a manner that the video image information amount becomes the maximum within the capacity of the receiving device with the same operations described in the flowchart of FIG. 5. Here, as in the case of the third exemplary embodiment, described is a case where the first variable length encoding method is MPEG2VLC and the second variable length encoding method is CABAC.

When the selection control unit 821 determines to transmit the bit stream with the second variable length encoding method, the second variable-length code encoding unit 827 transforms the encoding information of the corresponding bit rate among the stored encoding information 901 to 903, and transmits it. In the meantime, when the selection control unit 821 determines to transmit the bit stream with the first variable length encoding method, the encoding information of the corresponding bit rate among the stored encoding information 901 to 903 is transformed into the encoding information corresponding to the first variable length encoding method through the encoding information transform unit 828. Then, it is transformed to the bit stream by the first variable-length code encoding unit 826 and transmitted.

The fourth exemplary embodiment of the present invention makes it possible to achieve the video image delivery system which transmits the bit stream having the highest video image information amount within the decodable capacity of the receiving device through selecting by the transmission device whether to transmit the stored bit stream directly or to transmit the bit stream by changing the variable length encoding method based on the receiving device information without storing the bit streams corresponding to the entire variable length encoding methods and without performing inverse transformation processing for transforming the transformed bit stream back to the encoding information.

### Expansions of Each Exemplary Embodiment

While the first to fourth exemplary embodiments of the present invention have been described above, the present invention is not limited to those cases described as the exemplary embodiments but various kinds of expansions are possible. Hereinafter, possible expansions regarding the first to fourth exemplary embodiments will be described.

In the first to fourth exemplary embodiments, mainly the examples of the exemplary embodiments according to the variable length encoding methods of H.264 and MPEG-2 have been described. However, the present invention is not limited to be applied only with those variable length encoding methods. It is also possible to use the variable length encoding methods of H.261, H.263, MPEG-4, VC-1, and the like or the variable length encoding methods that are not included in the video image encoding methods and the like of the international standards.

Further, while the examples of the case of using the two kinds of variable length encoding methods are mainly described in the first to fourth exemplary embodiments, the present invention can easily be expanded to cases where there are three or more kinds of variable length encoding methods.

Further, various types can be considered as the unit of selecting the variable length encoding methods. It is possible to select the different variable length encoding methods for each of the units, e.g., the entire bit stream, GOP (Group Of Pictures), picture, and slice. In particular, there are cases where the encoding efficiency of the variable length encoding method varies depending on the picture types (I picture, P picture, B picture, etc.), so that it is considered to switch the variable length encoding method by taking the difference of the encoding efficiency into consideration.

Further, selection of the variable length encoding method does not necessarily need to be fixed. When the maximum bit rate that can be decoding processed changes due to fluctuation and the like of the load of the receiving device, it is natural to transmit the receiving device information to the transmission device as necessary and to change the selection of the variable length encoding method based thereupon dynamically.

Further, while the example of the case of using the maximum bit rate that can be decoding processed by the receiving device as the processing efficiency information has been described, the processing efficiency information is not limited only to that. Various kinds of information regarding the processing efficiency of the variable length encoding methods can be used. For example, considered are the processing cycle number per specific bit rate, an expression of the relation between the bit rate and the encoding processing amount, and the like.

Furthermore, it is also considered to use not the decoding processing amount itself but the evaluation scales that vary depending on the usages as the processing efficiency information. For example, it is also possible to use the evaluation scale such as the power consumption amount per specific bit rate as the processing efficiency information.

Further, while the operation example of the case where the receiving device information is transmitted to the transmission device from the receiving device has been described, discriminating information of the receiving device may be transmitted without transmitting the receiving device information itself, and the transmission device may hold a database which associates the discriminating information with the receiving device information.

Furthermore, when the receiving device information cannot be acquired, it is also considered to use the maximum bit rate and the like determined according to the profile, level, and the like contained in a delivery request as the maximum bit rate that can be decoding processed by the receiving device.

The methods described above may be achieved by means of hardware by an electronic circuit or may be achieved by means of software by causing a computer to read a program from a recording medium and to execute it.

While the present invention has been described by referring to the specific exemplary embodiments illustrated in the drawings, the present invention is not limited only to those exemplary embodiments described above. Any other known structures can be employed, as long as the effects of the present invention can be achieved therewith.

Regarding each of the exemplary embodiments described above, the new technical contents of the above-described exemplary embodiments can be summarized as follows. While a part of or a whole part of the exemplary embodiments can be summarized as follows as the new techniques, the present invention is not necessarily limited only to the followings.

The programs of the computer are recorded to nontemporal recording media.

### (Supplementary Note 1)

A video image delivery system constituted by mutually connecting a transmission device and a receiving device, wherein:
the transmission device includes
a bit stream storage unit which transforms in advance video image signals into a plurality of bit streams of different bit rates and stores those,
a receiving device information acquisition unit which acquires receiving device information containing processing efficiency information when the receiving device performs decoding processing on the bit streams encoded by variable length encoding methods for each of a plurality of kinds of variable length encoding methods from the receiving device,
a selection control unit which determines the variable length encoding method and a bit rate of the bit stream that is to be transmitted to the receiving device based on the receiving device information, and
a transmission unit which transmits the bit stream of the variable length encoding method and the bit rate determined by the selection control unit to the receiving device;
the receiving device includes
a plurality of variable-length code decoding units for variable-length decoding the bit streams encoded by corresponding to each of the plurality of kinds of variable length encoding methods, and
an image outputting unit which transforms variable-length decoded signals into video images and outputs those; and
the selection control unit of the transmission device determines the variable length encoding method and the bit rate based on the processing efficiency information in such a manner that the bit rate is within a maximum bit rate that can be processed by the receiving device and that the video image information amount before being variable-length encoded becomes maximum.

### (Supplementary Note 2)

The video image delivery system as depicted in Supplementary Note 1, wherein:
the bit stream storage unit of the transmission device stores a plurality of bit streams of different bit rate encoded by the first variable length encoding method;
the transmission device includes a first variable-length code decoding unit which decodes the bit streams encoded by the first variable length encoding method and outputs coding information, and a second variable-length code encoding unit which encodes the encoding information by the second variable length encoding method and outputs the bit streams; and
the selection control unit of the transmission device transmits the bit streams encoded by the first variable length encoding method to the transmission unit for the receiving device via the first variable-length code decoding unit and the second variable-length code encoding unit, when determined to use the second variable length encoding method.

### (Supplementary Note 3)

The video image delivery system as depicted in Supplementary Note 2, wherein:
the transmission device includes an encoding information transform unit which, when there is a difference in the encoding information between the first variable length encoding method and the second variable length encoding method, performs transformation of the encoding information before encoding the encoding information decoded by the first variable-length code decoding unit by using the second variable length encoding method.

### (Supplementary Note 4)

The video image delivery system as depicted in Supplementary Note 1, wherein
the transmission device includes:
instead of the bit stream storage unit, an encoding information storage unit which stores in advance encoding information of a plurality of video images of different bit rates;
a plurality of variable-length code encoding units which encode the encoding information with a plurality of kinds of variable length encoding methods and output the bit streams; and
an encoding information transform unit which transforms the encoding information, when the variable length encoding method determined by the selection control unit is different from the variable length encoding method of the encoding information.

### (Supplementary Note 5)

The video image delivery system as depicted in Supplementary Note 3 or 4, wherein
the receiving device includes an encoding information inverse transform unit which performs transformation on the bit stream received from the transmission device in a direction inversed from that of the encoding information transform unit of the transmission device.

### (Supplementary Note 6)

The video image delivery system as depicted in any one of Supplementary Notes 1 to 5, wherein:
the receiving device includes a receiving device storage module which stores the receiving device information in advance and a receiving device information transmitting unit which transmits the receiving device information stored in the receiving device storage module to the transmission device; and
the receiving device information acquisition unit of the transmission device receives the receiving device information from the receiving device.

### (Supplementary Note 7)

The video image delivery system as depicted in any one of Supplementary Notes 1 to 6, wherein the selection control unit of the transmission device switches the plurality of variable length encoding methods for each picture encoding types of I picture, P picture, B picture, and the like.

### (Supplementary Note 8)

The video image delivery system as depicted in any one of Supplementary Notes 1 to 7, wherein the plurality of variable length encoding methods include one or more kinds selected from the variable length encoding methods of MPEG-2, MPEG-4, H.261, H263, H.264 CAVLC, H.264 CABAC, and VC-1.

### (Supplementary Note 9)

The video image delivery system as depicted in any one of Supplementary Notes 1 to 8, wherein the processing efficiency information is information regarding the maximum bit rate that can be processed by the receiving device.

### (Supplementary Note 10)

A video image transmission device connected mutually to a receiving device, which includes:
a bit stream storage unit which transforms in advance video image signals into a plurality of bit streams of different bit rates and stores those;
a receiving device information acquisition unit which acquires receiving device information containing processing efficiency information when the receiving device performs decoding processing on the bit streams encoded by variable length encoding methods for each of a plurality of kinds of variable length encoding methods from the receiving device;
a selection control unit which determines the variable length encoding method and a bit rate of the bit stream that is to be transmitted to the receiving device based on the receiving device information; and
a transmission unit which transmits the bit stream of the variable length encoding method and the bit rate determined by the selection control unit to the receiving device, wherein
the selection control unit of the transmission device determines the variable length encoding method and the bit rate based on the processing efficiency information in such a manner that the bit rate is within a maximum bit rate that can be processed by the receiving device and that the video image information amount before being variable-length encoded becomes maximum.

### (Supplementary Note 11)

A video image delivery method used with a video image delivery system constituted by mutually connecting a receiving device to a transmission device comprising a bit stream storage unit which transforms video image signals into a plurality of bit streams of different bit rates and stores those in advance, wherein:
a receiving device information acquisition unit of the transmission device acquires receiving device information containing processing efficiency information when the receiving device performs decoding processing on the bit streams encoded by variable length encoding methods for each of a plurality of kinds of variable length encoding methods from the receiving device;
a selection control unit of the transmission device determines the variable length encoding method and a bit rate of the bit stream that is to be transmitted to the receiving device based on the receiving device information in such a manner that the bit rate is within a maximum bit rate that can be processed by the receiving device and that the video image information amount before being variable-length encoded becomes maximum;
a transmission unit of the transmission device transmits the bit stream of the variable length encoding method and the bit rate determined by the selection control unit to the receiving device;
a variable-length code decoding unit of the receiving device performs variable-length decoding of the bit streams that are encoded by corresponding to each of the plurality of kinds of variable length encoding methods; and
an image outputting unit of the receiving device transforms the variable-length code decoded signals into video images and outputs those.

### (Supplementary Note 12)

A video image delivery program used with a video image delivery system constituted by mutually connecting a receiving device to a transmission device comprising a bit stream storage unit which transforms video image signals into a plurality of bit streams of different bit rates and stores those in advance, and the program causes a computer provided to the transmission device to execute:
a procedure for acquiring receiving device information containing processing efficiency information when the receiving device performs decoding processing on the bit streams encoded by variable length encoding methods for each of a plurality of kinds of variable length encoding methods from the receiving device;
a procedure for determining the variable length encoding method and a bit rate of the bit stream that is to be transmitted to the receiving device based on the receiving device information in such a manner that the bit rate is within a maximum bit rate that can be processed by the receiving device and that the video image information amount before being variable-length encoded becomes maximum; and
a procedure for transmitting the bit stream of the variable length encoding method and the bit rate determined by the selection control unit to the receiving device.

This application claims the Priority right based on Japanese Patent Application No. 2010-118098 filed on May 24, 2010 and the disclosure thereof is hereby incorporated by reference in its entirety.

### INDUSTRIAL APPLICABILITY

The present invention can be broadly utilized for delivering video images by utilizing a network.

### REFERENCE NUMERALS

1, 301, 601, 801 Video image delivery system
10, 310, 610, 810 Transmission device
11, 51 Main computation control module
12, 52 Storage module
13, 53 Communication module
21, 321, 621, 821 Selection control unit
22 Transmission unit
23 Receiving device information acquisition unit
24, 324, 624 Bit stream storage unit
25, 325, 625, 825 Video image information amount information
50, 650 Receiving device
54 Operation module
55 Display module
61 Reception control unit
62 First variable-length code decoding unit
63 Second variable-length code decoding unit
64 Receiving device information transmitting unit
65 Image outputting unit
66 Receiving device information
80 Network
101-106, 401-404, 701-703 Bit stream
326, 626 First variable-length code decoding unit
327, 627, 827 Second variable-length code encoding unit
628, 828 Encoding information transform unit
667 Encoding information inverse transform unit
824 Encoding information storage unit
826 First variable-length code encoding unit
901-903 Encoding information

What is claimed is:

1. A video image delivery system constituted by mutually connecting a transmission device and a receiving device, wherein:
the transmission device comprises
a bit stream storage unit which transforms in advance video image signals into a plurality of bit streams of different bit rates and stores those,
a receiving device information acquisition unit which acquires receiving device information containing processing efficiency information when the receiving device performs decoding processing on the bit streams encoded by variable length encoding methods for each of a plurality of kinds of variable length encoding methods from the receiving device,
a selection control unit which determines the variable length encoding method and a bit rate of the bit stream that is to be transmitted to the receiving device based on the receiving device information, and
a transmission unit which transmits the bit stream of the variable length encoding method and the bit rate determined by the selection control unit to the receiving device;
the receiving device comprises
a plurality of variable-length code decoding units for variable-length decoding the bit streams encoded by corresponding to each of the plurality of kinds of variable length encoding methods, and
an image outputting unit which transforms variable-length decoded signals into video images and outputs those; and
the selection control unit of the transmission device determines the variable length encoding method and the bit rate based on the processing efficiency information in such a manner that the bit rate is within a maximum bit rate that can be processed by the receiving device and that the video image information amount before being variable-length encoded becomes maximum.

2. The video image delivery system as claimed in claim 1, wherein:
the bit stream storage unit of the transmission device stores a plurality of bit streams of different bit rate encoded by the first variable length encoding method;
the transmission device comprises a first variable-length code decoding unit which decodes the bit streams encoded by the first variable length encoding method and outputs coding information, and a second variable-length code encoding unit which encodes the encoding information by the second variable length encoding method and outputs the bit streams; and
the selection control unit of the transmission device transmits the bit streams encoded by the first variable length encoding method to the transmission unit for the receiving device via the first variable-length code decoding unit and the second variable-length code encoding unit, when determined to use the second variable length encoding method.

3. The video image delivery system as claimed in claim 2, wherein:
the transmission device comprises an encoding information transform unit which, when there is a difference in the encoding information between the first variable length encoding method and the second variable length encoding method, performs transformation of the encoding information before encoding the encoding information decoded by the first variable-length code decoding unit by using the second variable length encoding method.

4. The video image delivery system as claimed in claim 1, wherein
the transmission device comprises:
instead of the bit stream storage unit, an encoding information storage unit which stores in advance encoding information of a plurality of video images of different bit rates;
a plurality of variable-length code encoding units which encode the encoding information with a plurality of kinds of variable length encoding methods and output the bit streams; and
an encoding information transform unit which transforms the encoding information, when the variable length encoding method determined by the selection control unit is different from the variable length encoding method of the encoding information.

5. The video image delivery system as claimed in claim 3, wherein
the receiving device comprises an encoding information inverse transform unit which performs transformation on the bit stream received from the transmission device in a direction inversed from that of the encoding information transform unit of the transmission device.

6. The video image delivery system as claimed in claim 1, wherein:
the receiving device comprises a storage module which stores the receiving device information in advance and a receiving device information transmitting unit which transmits the receiving device information to the transmission device; and
the receiving device information acquisition unit of the transmission device receives the receiving device information from the receiving device.

7. A video image transmission device connected mutually to a receiving device, comprising:
a bit stream storage unit which transforms in advance video image signals into a plurality of bit streams of different bit rates and stores those;
a receiving device information acquisition unit which acquires receiving device information containing processing efficiency information when the receiving device performs decoding processing on the bit streams encoded by variable length encoding methods for each of a plurality of kinds of variable length encoding methods from the receiving device;
a selection control unit which determines the variable length encoding method and a bit rate of the bit stream that is to be transmitted to the receiving device based on the receiving device information; and
a transmission unit which transmits the bit stream of the variable length encoding method and the bit rate determined by the selection control unit to the receiving device, wherein
the selection control unit of the transmission device determines the variable length encoding method and the bit rate based on the processing efficiency information in such a manner that the bit rate is within a maximum bit rate that can be processed by the receiving device and that the video image information amount before being variable-length encoded becomes maximum.

8. A video image delivery method used with a video image delivery system constituted by mutually connecting a receiving device to a transmission device comprising a bit stream storage unit which transforms video image signals into a plurality of bit streams of different bit rates and stores those in advance, wherein:
a receiving device information acquisition unit of the transmission device acquires receiving device information containing processing efficiency information when the receiving device performs decoding processing on the bit streams encoded by variable length encoding methods for each of a plurality of kinds of variable length encoding methods from the receiving device;
a selection control unit of the transmission device determines the variable length encoding method and a bit rate of the bit stream that is to be transmitted to the receiving device based on the receiving device information in such a manner that the bit rate is within a maximum bit rate that can be processed by the receiving device and that the video image information amount before being variable-length encoded becomes maximum;
a transmission unit of the transmission device transmits the bit stream of the variable length encoding method and the bit rate determined by the selection control unit to the receiving device;
a variable-length code decoding unit of the receiving device performs variable-length decoding of the bit streams that are encoded by corresponding to each of the plurality of kinds of variable length encoding methods; and
an image outputting unit of the receiving device transforms the variable-length code decoded signals into video images and outputs those.

9. A non-transitory computer readable recording medium storing a video image delivery program used with a video image delivery system constituted by mutually connecting a receiving device to a transmission device comprising a bit stream storage unit which transforms video image signals into a plurality of bit streams of different bit rates and stores those in advance, the program causing a computer provided to the transmission device to execute:
a procedure for acquiring receiving device information containing processing efficiency information when the receiving device performs decoding processing on the bit streams encoded by variable length encoding methods for each of a plurality of kinds of variable length encoding methods from the receiving device;
a procedure for determining the variable length encoding method and a bit rate of the bit stream that is to be transmitted to the receiving device based on the receiving device information in such a manner that the bit rate is within a maximum bit rate that can be processed by the receiving device and that the video image information amount before being variable-length encoded becomes maximum; and
a procedure for transmitting the bit stream of the variable length encoding method and the bit rate determined by the selection control unit to the receiving device.

10. A video image delivery system constituted by mutually connecting a transmission device and a receiving device, wherein:
the transmission device comprises
bit stream storage means for transforming in advance video image signals into a plurality of bit streams of different bit rates and storing those,
receiving device information acquisition means for acquiring receiving device information containing processing efficiency information when the receiving device performs decoding processing on the bit streams encoded by variable length encoding methods for each of a plurality of kinds of variable length encoding methods from the receiving device,
selection control means for determining the variable length encoding method and a bit rate of the bit stream that is to be transmitted to the receiving device based on the receiving device information, and
transmission means for transmitting the bit stream of the variable length encoding method and the bit rate determined by the selection control means to the receiving device;
the receiving device comprises
plurality of variable-length code decoding means for variable-length decoding the bit streams encoded by corresponding to each of the plurality of kinds of variable length encoding methods, and
image outputting means for transforming variable-length decoded signals into video images and outputting those; and
the selection control means of the transmission device for determining the variable length encoding method and the bit rate based on the processing efficiency information in such a manner that the bit rate is within a maximum bit rate that can be processed by the receiving device and that the video image information amount before being variable-length encoded becomes maximum.
